(19) United States
(12) Patent Application Publication
(10) Pub. No.: US 2022/0232408 A1
(43) Pub. Date: Jul. 21, 2022

(54) METHOD AND DEVICE FOR MEASURING CHANNEL IN CONCURRENT MODE OF NR V2X

(71) Applicant: LG Electronics Inc., Seoul (KR)

(72) Inventors: Jongyoul LEE, Seoul (KR); Youngdae LEE, Seoul (KR); Hanbyul SEO, Seoul (KR); Giwon PARK, Seoul (KR); Seungmin LEE, Seoul (KR)

(21) Appl. No.: 17/577,670

(22) Filed: Jan. 18, 2022

Related U.S. Application Data
(63) Continuation of application No. PCT/KR2020/008876, filed on Jul. 8, 2020.
(60) Provisional application No. 62/887,626, filed on Aug. 15, 2019.

(30) Foreign Application Priority Data
Jul. 17, 2019 (KR) 10-2019-0086453
Sep. 26, 2019 (KR) 10-2019-0119130

(51) Int. Cl. H04W 24/10; H04W 24/08; H04L 5/00

(52) U.S. Cl. CPC H04W 24/10; H04L 5/0048; H04W 24/08

(57) ABSTRACT

Proposed is a method for operating a first device (100) in a wireless communication system. The method may include the steps of: transmitting information including a destination identifier (ID) pertaining to a second device (200) to a base station (300); receiving a first measurement setting pertaining to the destination ID from the base station (300) on the basis of the destination ID; transmitting the first measurement setting to the second device (200) on the basis of the destination ID; transmitting a reference signal to the second device (200); and receiving information pertaining to a channel state from the second device (200).

### CROSS-REFERENCE TO RELATED APPLICATIONS

Pursuant to 35 U.S.C. § 119(e), this application is a continuation of International Application PCT/KR2020/008876, with an international filing date of Jul. 8, 2020, which claims the benefit of U.S. Provisional Patent Application No. 62/887,626, filed on Aug. 15, 2019, Korean Patent Application No. 10-2019-0086453, filed on Jul. 17, 2019 and Korean Patent Application No. 10-2019-0119130, filed on Sep. 26, 2019, the contents of which are hereby incorporated by reference herein in their entirety.

### BACKGROUND OF THE DISCLOSURE

### Field of the disclosure

This disclosure relates to a wireless communication system.

### Related Art

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

FIG. 1 is a drawing for describing V2X communication based on NR, compared to V2X communication based on RAT used before NR. The embodiment of FIG. 1 may be combined with various embodiments of the present disclosure.

Regarding V2X communication, a scheme of providing a safety service, based on a V2X message such as BSM (Basic Safety Message), CAM (Cooperative Awareness Message), and DENM (Decentralized Environmental Notification Message) is focused in the discussion on the RAT used before the NR. The V2X message may include position information, dynamic information, attribute information, or the like. For example, a UE may transmit a periodic message type CAM and/or an event triggered message type DENM to another UE.

For example, the CAM may include dynamic state information of the vehicle such as direction and speed, static data of the vehicle such as a size, and basic vehicle information such as an exterior illumination state, route details, or the like. For example, the UE may broadcast the CAM, and latency of the CAM may be less than 100 ms. For example, the UE may generate the DENM and transmit it to another UE in an unexpected situation such as a vehicle breakdown, accident, or the like. For example, all vehicles within a transmission range of the UE may receive the CAM and/or the DENM. In this case, the DENM may have a higher priority than the CAM.

Thereafter, regarding V2X communication, various V2X scenarios are proposed in NR. For example, the various V2X scenarios may include vehicle platooning, advanced driving, extended sensors, remote driving, or the like.

For example, based on the vehicle platooning, vehicles may move together by dynamically forming a group. For example, in order to perform platoon operations based on the vehicle platooning, the vehicles belonging to the group may receive periodic data from a leading vehicle. For example, the vehicles belonging to the group may decrease or increase an interval between the vehicles by using the periodic data.

For example, based on the advanced driving, the vehicle may be semi-automated or fully automated. For example, each vehicle may adjust trajectories or maneuvers, based on data obtained from a local sensor of a proximity vehicle and/or a proximity logical entity. In addition, for example, each vehicle may share driving intention with proximity vehicles.

For example, based on the extended sensors, raw data, processed data, or live video data obtained through the local sensors may be exchanged between a vehicle, a logical entity, a UE of pedestrians, and/or a V2X application server. Therefore, for example, the vehicle may recognize a more improved environment than an environment in which a self-sensor is used for detection.

For example, based on the remote driving, for a person who cannot drive or a remote vehicle in a dangerous environment, a remote driver or a V2X application may operate or control the remote vehicle. For example, if a route is predictable such as public transportation, cloud computing based driving may be used for the operation or control of the remote vehicle. In addition, for example, an access for a cloud-based back-end service platform may be considered for the remote driving.

Meanwhile, a scheme of specifying service requirements for various V2X scenarios such as vehicle platooning, advanced driving, extended sensors, remote driving, or the like is discussed in NR-based V2X communication.

### SUMMARY OF THE DISCLOSURE

### Technical Solutions

According to an embodiment, a method of operating a first apparatus 100 in a wireless communication system is proposed. The method may include: transmitting information including a destination identifier (ID) related to a second apparatus 200 to a base station 300; receiving a first measurement configuration related to the destination ID from the base station 300, based on the destination ID; transmitting the first measurement configuration to the second apparatus 200, based on the destination ID; transmitting a reference signal to the second apparatus 200; and receiving information related to a channel state from the second apparatus 200.

### EFFECTS OF THE DISCLOSURE

The user equipment (UE) may efficiently perform SL communication.

### BRIEF DESCRIPTION OF THE DRAWINGS

FIG. 1 is a drawing for describing V2X communication based on NR, compared to V2X communication based on RAT used before NR.

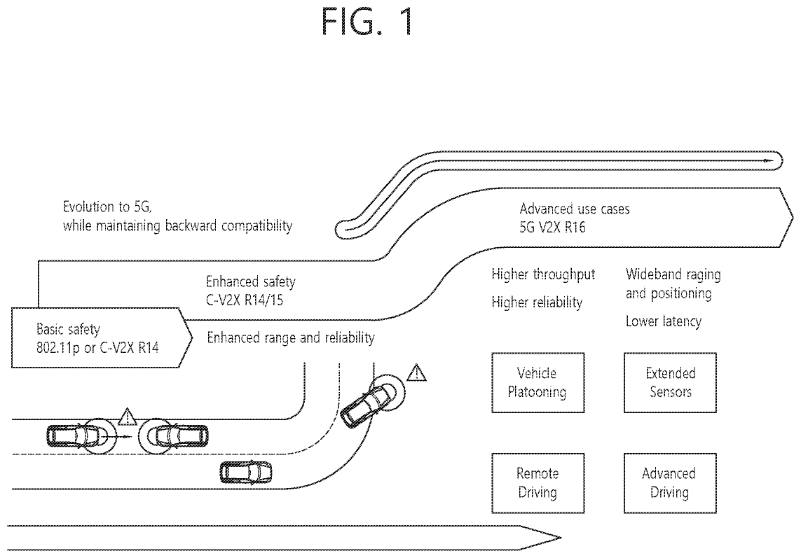

FIG. 2 shows a structure of an NR system, in accordance with an embodiment of the present disclosure.

FIG. 3 shows a functional division between an NG-RAN and a 5GC, in accordance with an embodiment of the present disclosure.

FIG. 4 shows a radio protocol architecture, in accordance with an embodiment of the present disclosure.

FIG. 5 shows a structure of an NR system, in accordance with an embodiment of the present disclosure.

FIG. 6 shows a structure of a slot of an NR frame, in accordance with an embodiment of the present disclosure.

FIG. 7 shows an example of a BWP, in accordance with an embodiment of the present disclosure.

FIG. 8 shows a radio protocol architecture for a SL communication, in accordance with an embodiment of the present disclosure.

FIG. 9 shows a UE performing V2X or SL communication, in accordance with an embodiment of the present disclosure.

FIG. 10 shows a procedure of performing V2X or SL communication by a UE based on a transmission mode, in accordance with an embodiment of the present disclosure.

FIG. 11 shows three cast types, in accordance with an embodiment of the present disclosure.

FIG. 12 shows a procedure of measuring a sidelink channel performed according to a resource allocation mode according to an embodiment of the present disclosure.

FIG. 13 shows a procedure for a transmitting UE to receive information related to a channel state, measured based on a first measurement configuration, according to an embodiment of the present disclosure.

FIG. 14 shows a procedure for a transmitting UE to receive information related to a channel state, measured based on a second measurement configuration, according to an embodiment of the present disclosure.

FIG. 15 shows a procedure for a transmitting UE to receive information related to a channel state from one or more receiving UEs according to an embodiment of the present disclosure.

FIG. 16 shows a procedure in which a UE performs signaling of a measurement configuration according to an embodiment of the present disclosure.

FIG. 17 shows a procedure in which a first apparatus receives information related to a channel state from a second apparatus, according to an embodiment of the present disclosure.

FIG. 18 shows a procedure in which a base station transmits a first measurement configuration to a first apparatus, according to an embodiment of the present disclosure.

FIG. 19 shows a procedure in which a transmitting UE performs data transmission according to an embodiment of the present disclosure.

FIG. 20 shows a procedure in which a transmitting UE performs data transmission based on resource selection through mode 2 according to an embodiment of the present disclosure.

FIG. 21 shows a communication system 1, in accordance with an embodiment of the present disclosure.

FIG. 22 shows wireless devices, in accordance with an embodiment of the present disclosure.

FIG. 23 shows a signal process circuit for a transmission signal, in accordance with an embodiment of the present disclosure.

FIG. 24 shows a wireless device, in accordance with an embodiment of the present disclosure.

FIG. 25 shows a hand-held device, in accordance with an embodiment of the present disclosure.

FIG. 26 shows a car or an autonomous vehicle, in accordance with an embodiment of the present disclosure.

### DESCRIPTION OF EXEMPLARY EMBODIMENTS

In the present specification, “A or B” may mean “only A”, “only B” or “both A and B.” In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDDCH” may be proposed as an example of the “control information”. In addition, when indicated as “control information (i.e., PDCCH)”, it may also mean that “PDCCH” is proposed as an example of the “control information”.

A technical feature described individually in one figure in the present specification may be individually implemented, or may be simultaneously implemented.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

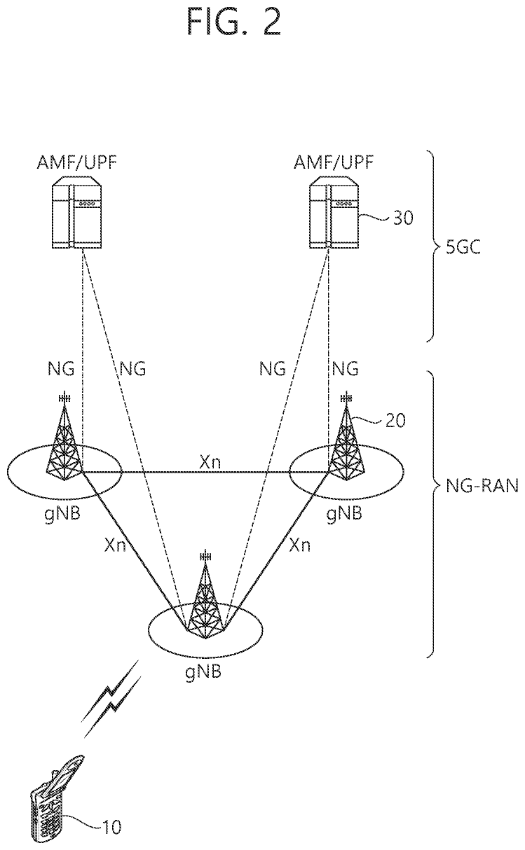

FIG. 2 shows a structure of an NR system, in accordance with an embodiment of the present disclosure. The embodiment of FIG. 2 may be combined with various embodiments of the present disclosure.

Referring to FIG. 2, a next generation-radio access network (NG-RAN) may include a BS 20 providing a UE 10 with a user plane and control plane protocol termination. For example, the BS 20 may include a next generation-Node B (gNB) and/or an evolved-NodeB (eNB). For example, the UE 10 may be fixed or mobile and may be referred to as other terms, such as a mobile station (MS), a user terminal (UT), a subscriber station (SS), a mobile terminal (MT), wireless device, and so on. For example, the BS may be referred to as a fixed station which communicates with the UE 10 and may be referred to as other terms, such as a base transceiver system (BTS), an access point (AP), and so on.

The embodiment of FIG. 2 exemplifies a case where only the gNB is included. The BSs 20 may be connected to one another via Xn interface. The BS 20 may be connected to one another via 5th generation (5G) core network (5GC) and NG interface. More specifically, the BSs 20 may be connected to an access and mobility management function (AMF) 30 via NG-C interface, and may be connected to a user plane function (UPF) 30 via NG-U interface.

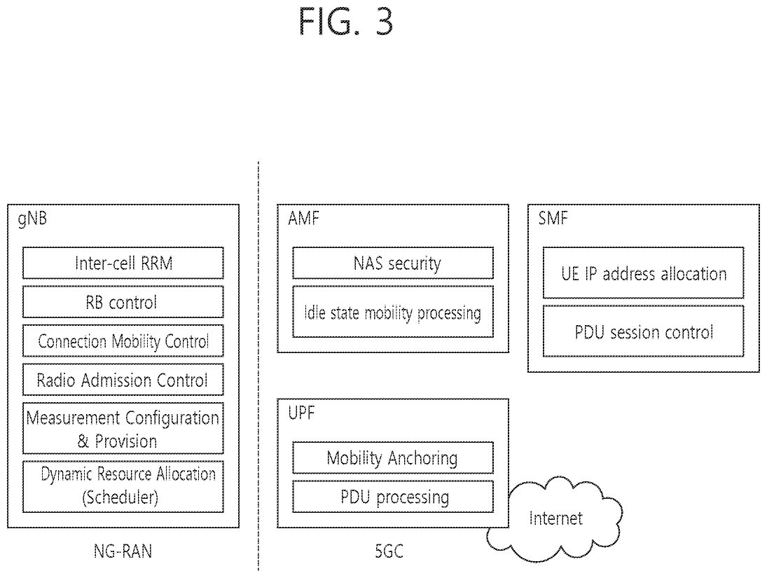

FIG. 3 shows a functional division between an NG-RAN and a 5GC, in accordance with an embodiment of the present disclosure.

Referring to FIG. 3, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

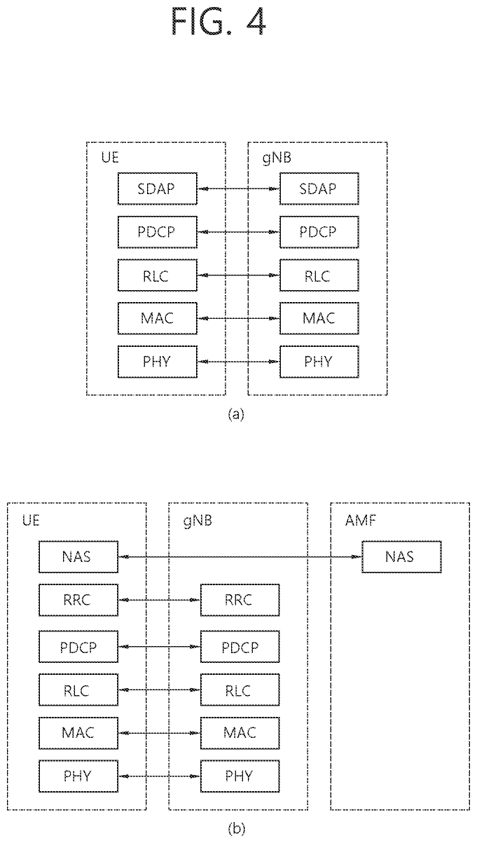

FIG. 4 shows a radio protocol architecture, in accordance with an embodiment of the present disclosure. The embodiment of FIG. 4 may be combined with various embodiments of the present disclosure. Specifically, FIG. 4(a) shows a radio protocol architecture for a user plane, and FIG. 4(b) shows a radio protocol architecture for a control plane. The user plane corresponds to a protocol stack for user data transmission, and the control plane corresponds to a protocol stack for control signal transmission.

Referring to FIG. 4, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., the MAC layer, the RLC layer, and the packet data convergence protocol (PDCP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several sub-carriers in a frequency domain. One sub-frame includes a plurality of OFDM symbols in the time domain. A resource block is a unit of resource allocation, and consists of a plurality of OFDM symbols and a plurality of sub-carriers. Further, each subframe may use specific sub-carriers of specific OFDM symbols (e.g., a first OFDM symbol) of a corresponding subframe for a physical downlink control channel (PDCCH), i.e., an L1/L2 control channel. A transmission time interval (TTI) is a unit time of subframe transmission.

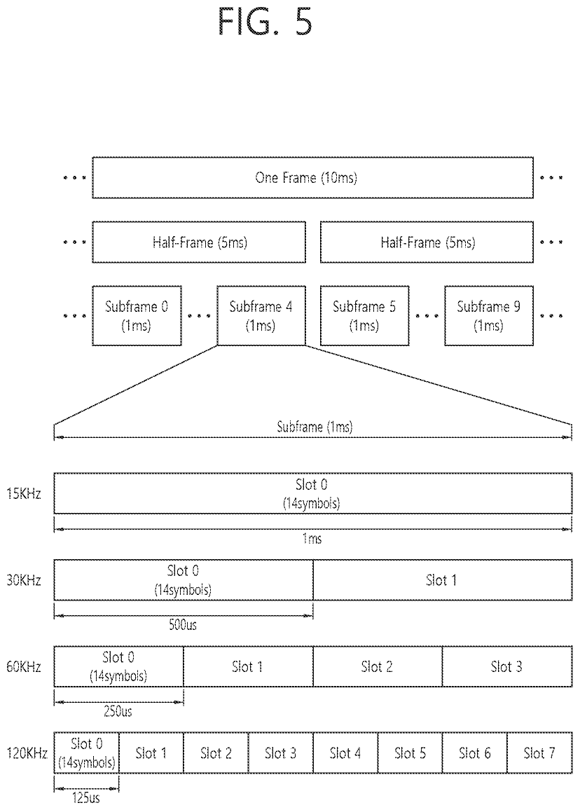

FIG. 5 shows a structure of an NR system, in accordance with an embodiment of the present disclosure. The embodiment of FIG. 5 may be combined with various embodiments of the present disclosure.

Referring to FIG. 5, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined in accordance with subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table 1 shown below represents an example of a number of symbols per slot (N^{slot}_{symb}), a number slots per frame (N^{frame,u}ₛₗₒₜ), and a number of slots per subframe (N^{subframe,u}ₛₗₒₜ) in accordance with an SCS configuration (u), in a case where a normal CP is used.

TABLE 1

| SCS (15*2^{u}) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

Table 2 shows an example of a number of symbols per slot, a number of slots per frame, and a number of slots per subframe in accordance with the SCS, in a case where an extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table 3. Among the frequency ranges that are used in an NR system, FR1 may mean a “sub 6 GHz range”, and FR2 may mean an “above 6 GHz range” and may also be referred to as a millimeter wave (mmW).

TABLE 3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed (or varied). For example, as shown below in Table 4, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

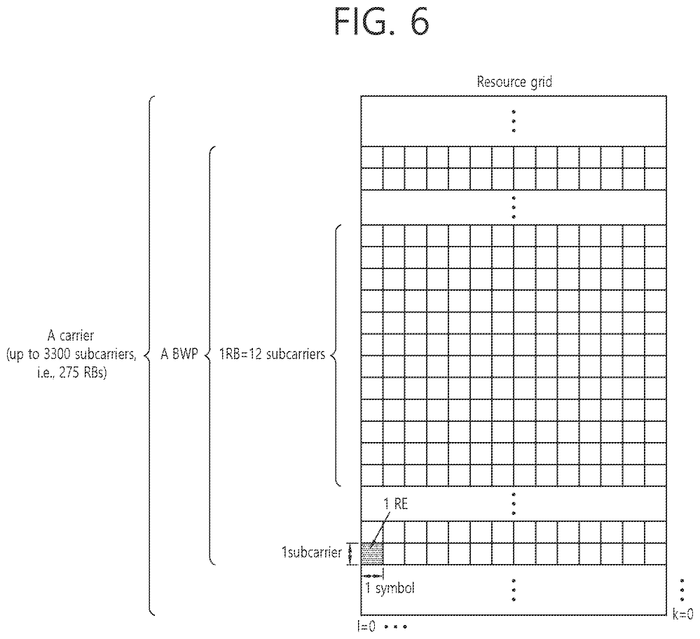

FIG. 6 shows a structure of a slot of an NR frame, in accordance with an embodiment of the present disclosure.

Referring to FIG. 6, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Meanwhile, a radio interface between a UE and another UE or a radio interface between the UE and a network may consist of an L1 layer, an L2 layer, and an L3 layer. In various embodiments of the present disclosure, the L1 layer may imply a physical layer. In addition, for example, the L2 layer may imply at least one of a MAC layer, an RLC layer, a PDCP layer, and an SDAP layer. In addition, for example, the L3 layer may imply an RRC layer.

Hereinafter, a bandwidth part (BWP) and a carrier will be described.

The BWP may be a set of consecutive physical resource blocks (PRBs) in a given numerology. The PRB may be selected from consecutive sub-sets of common resource blocks (CRBs) for the given numerology on a given carrier.

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a position change of the bandwidth, or a change in subcarrier spacing of the bandwidth.

For example, the bandwidth may be decreased during a period in which activity is low to save power. For example, the position of the bandwidth may move in a frequency domain. For example, the position of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be called a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, PDSCH, or CSI-RS (excluding RRM) outside the active DL BWP. For example, the UE may not trigger a channel state information (CSI) report for the inactive DL BWP. For example, the UE may not transmit PUCCH or PUSCH outside an active UL BWP. For example, in a downlink case, the initial BWP may be given as a consecutive RB set for an RMSI CORESET (configured by PBCH). For example, in an uplink case, the initial BWP may be given by SIB for a random access procedure. For example, the default BWP may be configured by a higher layer. For example, an initial value of the default BWP may be an initial DL BWP. For energy saving, if the UE fails to detect DCI during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

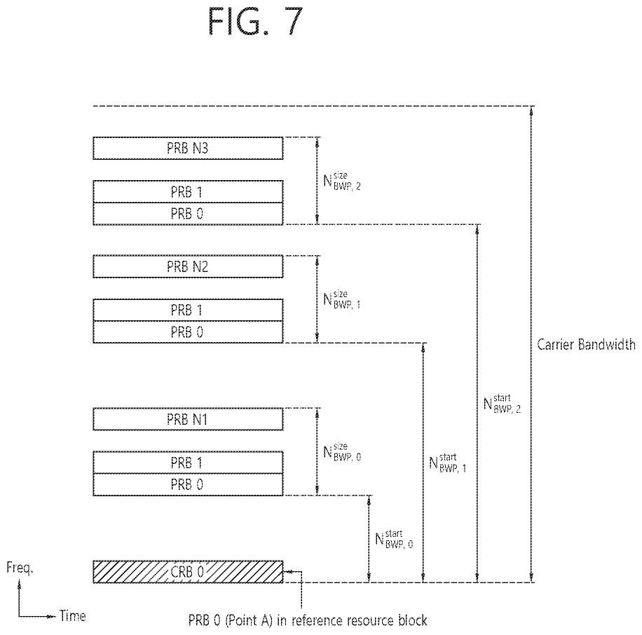

FIG. 7 shows an example of a BWP, in accordance with an embodiment of the present disclosure. The embodiment of FIG. 7 may be combined with various embodiments of the present disclosure. It is assumed in the embodiment of FIG. 7 that the number of BWPs is 3.

Referring to FIG. 7, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{BWP} from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described.

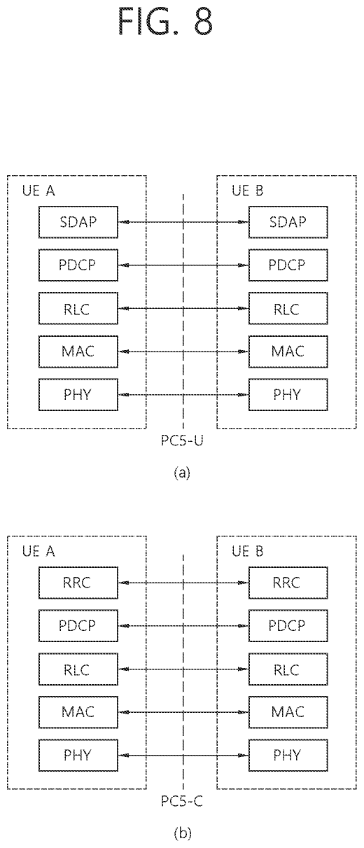

FIG. 8 shows a radio protocol architecture for a SL communication, in accordance with an embodiment of the present disclosure. The embodiment of FIG. 8 may be combined with various embodiments of the present disclosure. More specifically, FIG. 8(a) shows a user plane protocol stack, and FIG. 8(b) shows a control plane protocol stack.

Hereinafter, a sidelink synchronization signal (SLSS) and synchronization information will be described.

The SLSS may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit CRC.

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

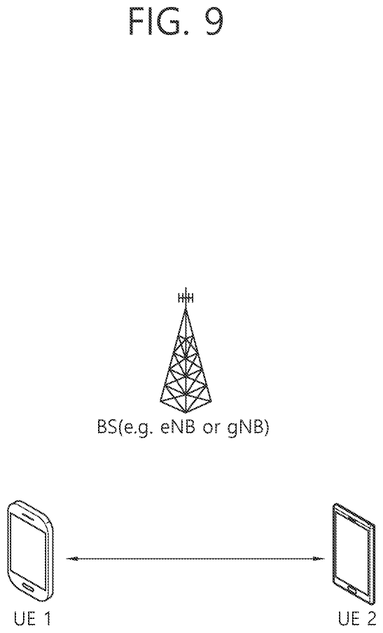

FIG. 9 shows a UE performing V2X or SL communication, in accordance with an embodiment of the present disclosure. The embodiment of FIG. 9 may be combined with various embodiments of the present disclosure.

Referring to FIG. 9, in V2X or SL communication, the term ‘UE’ may generally imply a UE of a user. However, if a network equipment such as a BS transmits/receives a signal according to a communication scheme between UEs, the BS may also be regarded as a sort of the UE. For example, a UE 1 may be a first apparatus 100, and a UE 2 may be a second apparatus 200.

For example, the UE 1 may select a resource unit corresponding to a specific resource in a resource pool which implies a set of series of resources. In addition, the UE 1 may transmit an SL signal by using the resource unit. For example, a resource pool in which the UE 1 is capable of transmitting a signal may be configured to the UE 2 which is a receiving UE, and the signal of the UE 1 may be detected in the resource pool.

Herein, if the UE 1 is within a connectivity range of the BS, the BS may inform the UE 1 of the resource pool. Otherwise, if the UE 1 is out of the connectivity range of the BS, another UE may inform the UE 1 of the resource pool, or the UE 1 may use a pre-configured resource pool.

In general, the resource pool may be configured in unit of a plurality of resources, and each UE may select a unit of one or a plurality of resources to use it in SL signal transmission thereof.

Hereinafter, resource allocation in SL will be described.

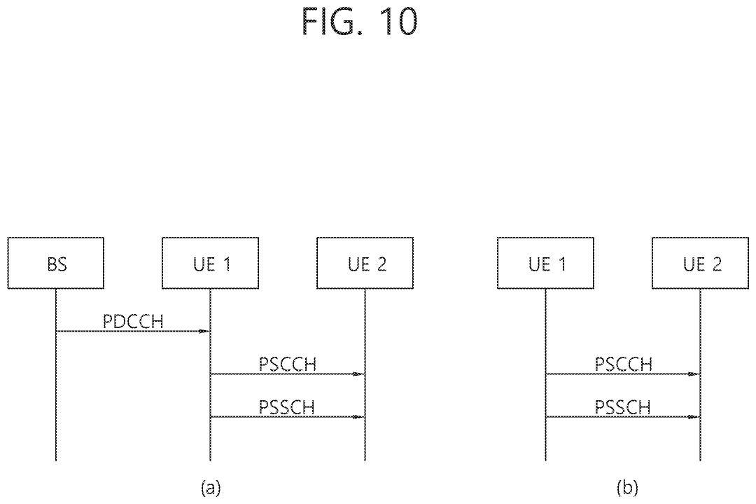

FIG. 10 shows a procedure of performing V2X or SL communication by a UE based on a transmission mode, in accordance with an embodiment of the present disclosure. The embodiment of FIG. 10 may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, FIG. 10(a) shows a UE operation related to an LTE transmission mode 1 or an LTE transmission mode 3. Alternatively, for example, FIG. 10(a) shows a UE operation related to an NR resource allocation mode 1. For example, the LTE transmission mode 1 may be applied to general SL communication, and the LTE transmission mode 3 may be applied to V2X communication.

For example, FIG. 10(b) shows a UE operation related to an LTE transmission mode 2 or an LTE transmission mode 4. Alternatively, for example, FIG. 10(b) shows a UE operation related to an NR resource allocation mode 2.

Referring to FIG. 10(a), in the LTE transmission mode 1, the LTE transmission mode 3, or the NR resource allocation mode 1, a BS may schedule an SL resource to be used by the UE for SL transmission. For example, the BS may perform resource scheduling to a UE 1 through a PDCCH (more specifically, downlink control information (DCI)), and the UE 1 may perform V2X or SL communication with respect to a UE 2 according to the resource scheduling. For example, the UE 1 may transmit a sidelink control information (SCI) to the UE 2 through a physical sidelink control channel (PSCCH), and thereafter transmit data based on the SCI to the UE 2 through a physical sidelink shared channel (PSSCH).

Referring to FIG. 10(b), in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannels. In addition, the UE 1 which has autonomously selected the resource within the resource pool may transmit the SCI to the UE 2 through a PSCCH, and thereafter may transmit data based on the SCI to the UE 2 through a PSSCH.

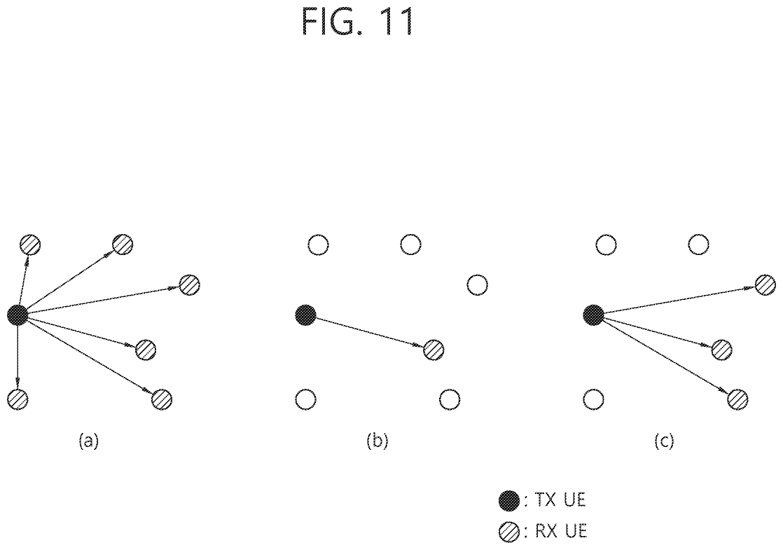

FIG. 11 shows three cast types, in accordance with an embodiment of the present disclosure. The embodiment of FIG. 11 may be combined with various embodiments of the present disclosure. Specifically, FIG. 11(a) shows broadcast-type SL communication, FIG. 11(b) shows unicast type-SL communication, and FIG. 11(c) shows groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

Hereinafter, SL measurement and reporting will be described.

For the purpose of QoS prediction, initial transmission parameter configuration, link adaptation, link management, admission control, or the like, SL measurement and reporting (e.g., RSRP, RSRQ) between UEs may be considered in SL. For example, a receiving UE may receive a reference signal from a transmitting UE, and the receiving UE may measure a channel state for the transmitting UE based on the reference signal. In addition, the receiving UE may report channel state information (CSI) to the transmitting UE. SL-related measurement and reporting may include measurement and reporting of CBR and reporting of location information. Examples of channel status information (CSI) for V2X may include a channel quality indicator (CQI), a precoding matrix index (PM), a rank indicator (RI), reference signal received power (RSRP), reference signal received quality (RSRQ), pathgain/pathloss, a sounding reference symbol (SRS) resource indicator (SRI), a SRI-RS resource indicator (CRI), an interference condition, a vehicle motion, or the like. In case of unicast communication, CQI, RI, and PMI or some of them may be supported in a non-subband-based aperiodic CSI report under the assumption of four or less antenna ports. A CSI procedure may not be dependent on a standalone reference signal (RS). A CSI report may be activated or deactivated based on a configuration.

For example, the transmitting UE may transmit CSI-RS to the receiving UE, and the receiving UE may measure CQI or RI based on the CSI-RS. For example, the CSI-RS may be referred to as SL CSI-RS. For example, the CSI-RS may be confined within PSSCH transmission. For example, the transmitting UE may perform transmission to the receiving UE by including the CSI-RS on the PSSCH.

Meanwhile, in a next generation system, various usage cases may be supported. For example, services for communication of self-driving vehicles, smart cars or connected cars, and so on, may be considered. For such services, each vehicle may receive and send (or transmit) information as a user equipment capable of performing communication. And, depending upon the circumstances, each vehicle may select resources for communication with the help (or assistance) of the base station or without any help (or assistance) of the base station and transmit and receive messages to and from other UEs.

On the other hand, in NR V2X, mode 1 and mode 2 were defined as a resource allocation mode, and two resource allocation modes may be simultaneously configured from the standpoint of one UE as follows. Here, mode 1 is a mode in which a base station performs resource allocation scheduling of a UE and gives a resource grant to the UE, and mode 2 is a mode in which the UE independently performs resource selection without an involvement of a base station. According to the contents described in Table 5 below, a UE may receive a configuration related to mode 1 and a configuration related to mode 2 at the same time, in what form a base station can configure the configurations or whether the configurations are pre-configured is an issue under discussion.

TABLE 5
1. Support for simultaneous configuration of Mode 1 and Mode 2 for a UE
1.1) Transmitter UE operation in this configuration is to be discussed
after the design of mode 1 only and mode 2 only.
1.2) Receiver UE can receive the transmissions without knowing the
resource allocation mode used by the transmitter UE.
2. Reference: [3GPP RP-190766]

For example, when a UE receives mode configurations for the both modes, different configurations can be defined for each mode configuration, or depending on which mode a UE operates in, the configurations the UE receives from a base station may be different. For example, configuration related to an operation related to measurement/report may be configured to mode 1 configuration, or configured to a UE from a base station, only when the UE performs an operation according to mode 1. In this disclosure, in terms of measurement/report of a UE, it is proposed that the UE prioritizes the operation according to which mode, in case that the UE receives the simultaneous configuration of mode 1/mode 2 as described above.

First, table 6 below shows a measurement configuration between a UE and a base station in NR Uu communication. For more specific details, refer to 3GPP TS 38.331.

TABLE 6
Measurement configuration

```
  1. Measurement object: A list of objects on which the UE shall perform
the measurements.
  2. Reporting configurations: A list of reporting configurations where
there can be one or multiple reporting configurations per measurement
object. Each reporting configuration consists of the following:
  2.1) Reporting criterion: The criterion that triggers the UE to send a
measurement report. This can either be periodical or a single event
description.
  2.2) RS type: The RS that the UE uses for beam and cell measurement
results (SS/PBCH block or CSI-RS).
  2.3) Reporting format: The quantities per cell and per beam that the
UE includes in the measurement report (e.g. RSRP) and other associated
information such as the maximum number of cells and the maximum
number beams per cell to report.
  3. Measurement identities: A list of measurement identities where
each measurement identity links one measurement object with one
reporting configuration.
  4. Quantity configurations: The quantity configuration defines the
measurement filtering configuration used for all event evaluation and
related a reporting, and for periodical reporting of that measurement.
  5. Measurement gaps: Periods that the UE may use to perform
measurements.
```

In NR sidelink (SL), if a UE operates in mode 1, similar to the Uu measurement, the UE may receive configuration for SL measurement/report as an RRC message. In this way, that the measurement configuration is configured by a base station means that the base station triggers a measurement/report of the sidelink between UEs. That is, a base station has control over an SL measurement, and a UE may perform inter-SL measurement based on the measurement configuration and reporting configuration received from the base station.

On the other hand, in NR SL, if a UE operates in mode 2, the UE may perform SL measurement/report without intervention of a base station. In this case, in general, the UE triggering the measurement may be a transmitting UE. At this time, the transmitting UE may piggyback a reference signal (RS) for measurement to data transmission and transmit it to a receiving UE, the transmitting UE may configure a configuration for the transmitting UE to use which resource the receiving UE will report, and/or under what conditions the receiving UE will report, and signal it to the receiving UE.

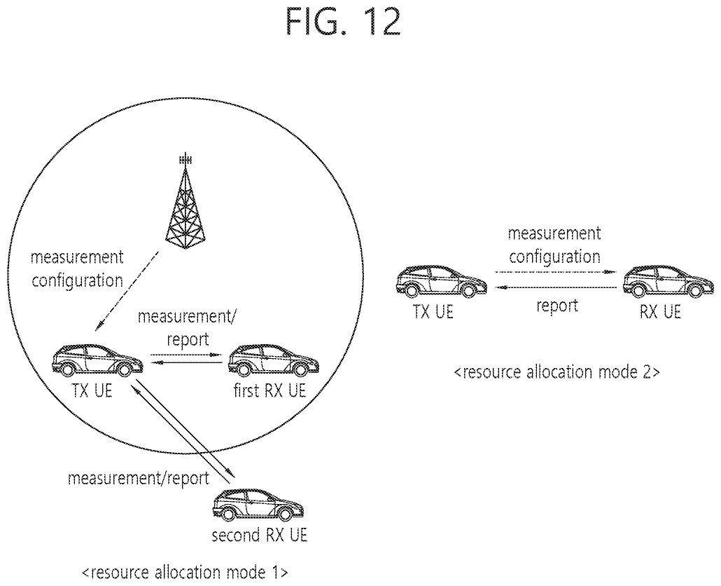

FIG. 12 shows a procedure of measuring a sidelink channel performed according to a resource allocation mode according to an embodiment of the present disclosure. The embodiment of FIG. 12 may be combined with various embodiments of the present disclosure.

Referring to FIG. 12, a process in which a transmitting UE (TX UE) signals the measurement configuration according to each mode described above is shown. In FIG. 12, a transmitting UE may receive a measurement configuration for each receiving UE (RX UE) from a base station. n addition, the transmitting UE may signal all or part of the configuration it has configured to each receiving UE, and transmit an RS to each receiving UE based on the measurement related parameters configured by the base station. Then, each receiving UE may perform channel measurement using the configured measurement RS, and report a measurement result to the transmitting UE based on a report-related parameter included in the measurement configuration received from the transmitting UE. For example, the configured measurement RS may include the RS received by each receiving UE from the transmitting UE.

Since a transmitting UE independently receives measurement configurations of each receiving UE, the transmitting UE may transmit information about which destination it is communicating with a UE related to in advance to a base station through SL UE information and/or UE assistance information. All destination IDs may be explicitly included in the two pieces of information to be signaled. Or, for example, the two pieces of information may be signaled by selecting and including only destination ID of a receiving UE that requires SL measurement for the transmitting UE to determine.

For example, when a base station transmits a measurement configurations for each receiving UE to a transmitting UE in the above case, the base station may transmit information indicating which receiving UE each measurement configuration is a measurement configuration for to the transmitting UE. For example, the information indicating which receiving UE each measurement configuration is a measurement configuration for may include information related to a destination identifier (ID). For example, the information related to the destination ID may include a destination index. In addition, for example, when the transmitting UE signals the measurement configuration to each of the receiving UE, the transmitting UE may signal the measurement configuration to each of the receiving UEs based on information related to the destination ID.

On the other hand, when a UE operates in mode 2, the transmitting UE may trigger a measurement by itself and may signal a measurement related configuration to a receiving UE. Then, the receiving UE may perform measurement and report based on the measurement configuration configured by the transmitting UE. For example, the receiving UE may perform measurement based on the measurement configuration. For example, the case in which the UE operates in mode 2 may include a case in which the UE is out of coverage of a base station (out-of-coverage).

In the present disclosure, when a UE receives the simultaneous configuration of mode 1 and mode 2, it is proposed which measurement configuration the UE prioritizes.

First, for example, from the viewpoint of resource selection, since an operation of selecting a resource in mode 2 has lower resource reliability than an operation of selecting a resource in mode 1 from the viewpoint of resource selection, if the UE performs resource selection in mode 2, it may be disadvantageous in occupying more resources. For example, when a UE performs resource selection in mode 2, the interference level may be higher. In addition, for example, since a UE receiving the simultaneous configurations of mode 1/mode 2 is basically an in-coverage UE, priority is given to the UE to receive resources and other signaling from the base station, unless in exceptional circumstances. Accordingly, it is proposed that a UE receiving the simultaneous configurations of mode 1/mode 2 prioritizes the measurement configuration configured by a base station.

For example, as an example of the above proposal, if a UE receives simultaneous configurations of mode 1/mode 2, there may be a method of preventing the UE from performing measurement/report related resource allocation according to the mode 2 operation, and preventing the UE from signaling the measurement configuration configured by the UE to the receiving UE. That is, since the UE can perform inter-SL measurement/report based only on the measurement configurations configured by the base station, the transmitting UE may signal or forward only the measurement configuration configured by the base station to the receiving UE.

According to an embodiment of the present disclosure, contrary to the above suggestion below, when a UE receives the simultaneous mode configurations, as an exception, a method is proposed in which mode 2 is prioritized over mode 1 so that the UE can configure the measurement configuration by itself and configure the measurement configuration to the receiving UE. First, the UE receiving the simultaneous mode may switch to the mode 2 based on the scheduling delay of a grant received based on the mode 1. For example, the UE that has been performing the measurement operation in mode 1 by receiving the simultaneous mode configurations may switch to mode 2 in a situation where the following conditions are satisfied, configure the measurement configuration by itself, and signal to the receiving UE.

For example, when a UE operating in mode 1 has a scheduling round trip delay of a resource allocation request process greater than a predetermined specific threshold, the UE may switch to mode 2 and configure the measurement configuration by itself to signal to a receiving UE. For example, a process for requesting resource allocation may be performed based on mode 1. For example, a procedure for resource allocation request performed based on the mode 1 may includes: transmitting, by a UE, a scheduling request (SR) to a base station; receiving, by the UE, a grant for a buffer status report (BSR) from the base station; transmitting the BSR to the base station by the UE; receiving the grand for data transmission from the base station, by the UE. For example, here, the predetermined specific threshold may be predefined by the base station in consideration of a latency budget and/or a scheduling delay of a service to be performed.

Alternatively, for example, a UE which has been operating in mode 1 may switch to mode 2 and configure a measurement configuration by itself and signal the measurement configuration to a receiving UE. For example, a process for requesting resource allocation may be performed based on mode 1. For example, the process for the resource allocation request performed based on the mode 1 may include: the UE transmitting an SR to the base station; receiving, by the UE, a grant for BSR from the base station; transmitting the BSR to the base station by the UE; the UE receiving a grant for data transmission from the base station.

Alternatively, for example, when the reliability of the QoS of the transmitted packet is lower than a specific threshold, a UE operating in mode 1 may switch to mode 2 and configure the measurement configuration by itself to signal a receiving UE. That is, the UE may transmit a packet with low reliability by switching to mode 2.

Alternatively, for example, a UE that has received a semi-persistent scheduling (SPS) resource from a base station may switch to mode 2, configure a measurement configuration by itself, and signal it to a receiving UE, when the time difference between SPS resources is greater than a predefined threshold or greater than the delay budget among QoS of a transmitted packet.

In the method proposed above, a UE may be defined to report specific information to a base station according to mode switching. For example, if a UE operating in mode 1 switches to mode 2, the UE may report an indication for mode switching to a base station. This indication may be interpreted as an indication that the base station does not signal the measurement related configuration any more. If there is no such indication report, a problem may occur in which the measurement configurations configured by the base station and the measurement configurations configured by the UE collide with each other.

Alternatively, for example, since a UE that has been configured to the simultaneous mode is basically an in-coverage UE, it is suitable for reporting sidelink related information to a base station. Accordingly, the UE in which the simultaneous mode is configured may be defined to periodically report specific information to the base station, and may allow the base station to determine whether to switch the specific mode or whether to configure the measurement configuration. For example, the sidelink-related information may include UE assistance information, SL UE information (SidelinkUEinformation), channel state information, and the like. For example, the specific information may include resource sensing information of a shared resource pool, preference for mode 1/mode 2 of the UE, the usage ratio of resources used for mode 1 or mode 2 among the resources allocated for mode 1/mode 2, CSI information measured in advance between sidelinks, PHY parameters of the UE. And the PHY parameter may include MCS, power control, and the like. For example, a UE periodically reports the information to a base station, and the base station may determine whether to signal by configuring measurement configurations to the transmitting UE based on the reported information.

According to an embodiment of the present disclosure, when a UE is configured to the simultaneous mode in NR (Next Radio) SL V2X, it is possible to handle under which measurement configuration the UE performs inter-SL measurement/report.

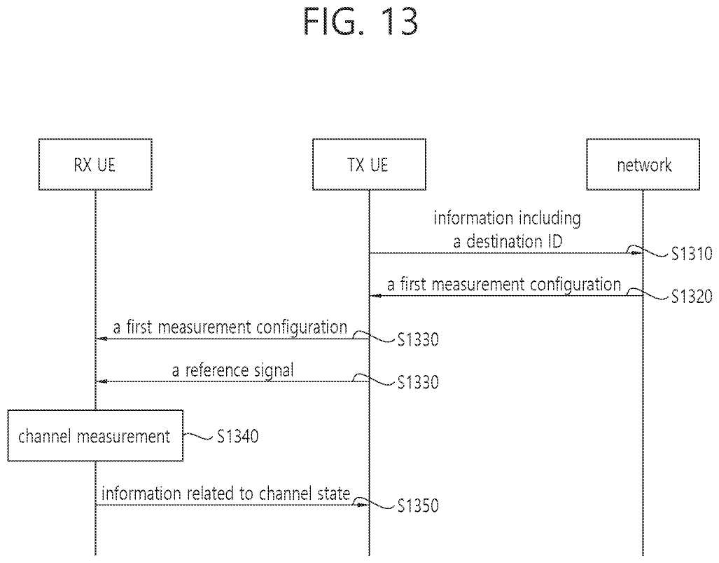

FIG. 13 shows a procedure for a transmitting UE to receive information related to a channel state, measured based on a first measurement configuration, according to an embodiment of the present disclosure. The embodiment of FIG. 13 may be combined with various embodiments of the present disclosure.

Referring to FIG. 13, in step S1310, a transmitting UE (TX UE) may transmit information including a destination ID to a network or a base station. For example, information including the destination ID may include SL UE information. The SL UE information may include SidelinkUEInformationNR. In step S1320, the network or the base station receiving the SL UE information may transmit a first measurement configuration to the transmitting UE. The first measurement configuration may be transmitted from the base station to the transmitting UE together with a destination index. For example, the destination ID may correspond to each receiving UE (RX UE). The destination index may correspond to a destination ID. That is, the destination index may indicate a receiving UE corresponding to a destination ID related to the destination index. For example, the first measurement configuration may be included in SL measurement configuration information. The SL measurement configuration information may include SL-MeasConfigInfo. For example, the SL measurement configuration information may be transmitted while being included in the NR SL configuration. The NR SL configuration may include SL-ConfigDedicatedNR. The NR SL configuration may be included in the RRC reconfiguration message and transmitted from the network or the base station to the transmitting UE. The RRC reconfiguration message may include an RRCReconfiguration message. For example, in step S1330, the transmitting UE may transmit the first measurement configuration to the receiving UE, and may transmit an RS related to channel measurement to the receiving UE. Here, the transmitting UE may transmit the corresponding measurement configuration to the receiving UE based on the destination index. The measurement configuration may be transmitted by being included in the sidelink RRC reconfiguration message. In step S1340, the receiving UE may perform channel measurement based on the RS and the first measurement configuration. In step S1350, the receiving UE may transmit, as a result of the performed channel measurement, information related to the channel state to the transmitting UE. Table 7 below shows messages related to the SL UE information.

TABLE 7
SidelinkUEInformationNR message

-- ASN1START
-- TAG-SIDELINKUEINFORMATIONNR-START

| | |
|---|---|
| SideLinkUEInformationNR-r16 ::= | SEQUENCE { |
| criticalExtensions | CHOICE { |
| sideLinkUEInformationNR-r16 | SidelinkUEInformationNR-r16-IEs, |
| criticalExtensionsFuture | SEQUENCE { } |

[symbol]

}

| SideLinkUEInformationNR-r16-IEs ::= | SEQUENCE { | |
|---|---|---|
| sl-TxInterestedFreqList-r16 | SL-TxInterestedFreqList-r16 | OPTIONAL, |
| sl-TxResourceReqList-r16 | SL-TxResourceReqList-r16 | OPTIONAL, |
| lateNonCriticalExtension | OCTET STRING | OPTIONAL, |
| nonCriticalExtension | SEQUENCE { } | OPTIONAL |

}

| SL-InterestedFreqList-r16 ::= | SEQUENCE (SIZE (1..maxNrofFreqSL-r16)) OF INTEGER (1..maxNrofFreqSL-r16), | |
|---|---|---|
| SL-TxResourceReqList-r16 ::= | SEQUENCE (SIZE (1..maxNrofSL-r16)) OF SL-TxResourceReq-r16, | |
| SL-TxResourceReq-r16 ::= | SEQUENCE { | |
| sl-DestinationIdentity-r16 | SL-DestinationIdentity-r16, | |
| sl-DestType-r16 | ENUMERATED (broadcast, groupcast, unicast, spare1), | |
| sl-RLS-ModeIndicationList-r16 | SEQUENCE (SIZE (1..maxNrofSLR3-r16)) OF SL-RLS-ModeIndication-r16 | OPTIONAL, |
| sl-QoS-InfoList-r16 | SEQUENCE (SIZE (1..maxNrofSL-QFInforDest-r16)) OF SL-QoS-Info-r16 | OPTIONAL, |
| sl-Faliure-r16 | ENUMERATED (r16, cofigFailure, spare2, spare1) | OPTIONAL, |
| sl-TypeTxSyncList-r16 | SEQUENCE (SIZE (1..maxNrofFreqSL-r16)) OF SL-TypeTxSync-r16 | OPTIONAL, |
| sl-TxInterestedFreqList-r16 | SEQUENCE (SIZE (1..maxNrofFreqSL-r16)) OF INTEGER (1..maxNrofFreqSL-r16) | OPTIONAL |

```
}
  sl-DestinationIdentity
  Indicates the destination for which the Tx resource request and allocation from the network are concerned. [symbol]
indicates data missing or illegible when filed
```

Table 8 below shows information elements related to the SL measurement configuration information.

TABLE 8
SL-MeasConfigInfo
The IE SL-MeasConfigInfo is used to set RSRP measurement configurations for outcast destionations
SL-MeasConfigInfo information elements

-- ASN1START
-- TAG-SL-MEASCONFIGINFO-START

| SL-MeasConfigInfor-r16 ::= | SEQUENCE { | |
|---|---|---|
| sl-DestinationIndex-r16 | SL-DestinationIndex-r16, | |
| sl-MeasConfig-r16 | SL-MeasConfig-r16 | OPTIONAL, -- Need N |

...
}

| SL-MeasConfig-r16 ::= | SEQUENCE { | |
|---|---|---|
| sl-MeasObjectToRemoveList-r16 | SL-MeasObjectToRemoveList-r16 | OPTIONAL, -- Need N |
| sl-MeasObjectToAddModList-r16 | SL-MeasObjectList-r16 | OPTIONAL, -- Need N |
| sl-ReportConfigToRemoveList-r16 | SL-ReportConfigToRemoveList-r16 | OPTIONAL, -- Need N |
| sl-ReportConfigToAddModList-r16 | SL-ReportConfigList-r16 | OPTIONAL, -- Need N |
| sl-MeasIdToRemoveList-r16 | SL-MeasIdToRemoveList-r16 | OPTIONAL, -- Need N |
| sl-MeasId | SL-MeasIdList-r16 | OPTIONAL, -- Need N |
| sl-QuantityConfig-r16 | SL-QuantityConfig-r16 | OPTIONAL, -- Need N |

...
}

| | |
|---|---|
| SL-MeasObjectToRemoveList-r16 ::= | SEQUENCE (SIZE (1..maxNrofSL-ObjectId-r16)) OF SL-MeaseObjectId-r16 |
| SL-ReportConfigToRemoveList-r16 ::= | SEQUENCE (SIZE (1..maxNrofSL-ReportConfigId-r16)) OF SL-ReportConfigId-r16 |
| SL-Meas [symbol] RemoveList-r16 | SEQUENCE (SIZE (1..maxNrofSL-MeasId-r16)) OF SL-MeasId-r16 |

```
-- TAG-SL-MEASCONFIGINFO-STOP
  sl-DestinationIndex
  Indicates the index of the destination for which the UE is interested to perform NR sidelink communication. The value 0 correspondes to the
  destination of the first entry in sl-TxResourceReqList in SidlinkUEInformationNR. The value 1 corresponds to the destination of the
  second entry in sl-TxResourceReqList in SidelinkUEInformationNR and so on.
  sl-MeasConfig
  Indicates the sidelink measurement configuration for the unicast destination. [symbol]
indicates data missing or illegible when filed
```

Table 9 below shows contents related to the RRC reconfiguration message.

TABLE 9
RRCReconfiguration
The RRCReconfiguration message is the command to modity an RRC connection. It may convey information
for measurment configuration, mob [symbol] y control, radio resource configuration (including RBs, MAC main
configuration and physical channel configuration) and AS security configuration.

```
    Signalling radio bearer: SRB1 or SRB2
    RLC-SAP: AM
    Logical channel: DCCH
    Direction: Network to UE
```

| | RRCReconfiguration message | |
|---|---|---|
| RRCToconfiguration-IEs ::= | SEQUENCE { | |
| radioBearerConfig | RadioBearerConfig | OPTIONAL, -- Need M |
| secondaryCellGroup | OCTET STRING {CCTAINING Cell GroupConfig} | OPTIONAL, -- Need M |
| measConfig | MeasConfig | OPTIONAL, -- Need M |
| lateNonCriticalExtension | OCTET STRING | OPTIONAL, |
| nonCriticalExtension | RRCReconfiguration-v1530-IEs | OPTIONAL |

}
RRCReconfiguration-IEs ::= -SEQUENCE {

| | | |
|---|---|---|
| otherConfig-v16xy | OtherConfig-v1 [symbol] xy | OPTIONAL, -- Need M |
| [symbol] -Config-r16 | SetupRelease { [symbol] -Config-r16 } | OPTIONAL, -- Need M |
| conditionalReconfiguration-r16 | ConditionalReconfiguration-r16 | OPTIONAL, -- Need M |
| [symbol] -SourceRelease-r16 | ENUMERATED{true} | OPTIONAL, -- Need M |
| sl-ConfigDedicatedNR-r16 | SetupRelease {SL-ConfigDedicatedNR-r16} | OPTIONAL, -- Need M |
| sl-ConfigDedicatedEUTRA-r16 | SetupRelease {SL-ConfigDedicatedEUTRA-r16} | OPTIONAL, -- Need M |
| nonCriticalExtension | SEQUENCE { } | OPTIONAL |

```
}
  sl-ConfigDedicatedNR
  This field is used to provide the dedicated configurations for NR sidelink communication. [symbol]
indicates data missing or illegible when filed
```

Table 10 below shows contents related to the SL RRC reconfiguration message.

TABLE 10
RRCReconfigurationSidelink
The RRCReconfigurationSidelink message is the command to AS configuration of the PC5 RRC
connection. It is only applied to unicast of NR sidelink communication

```
  Signalling radio bearer: Sidelink SRB for [symbol] -RRC
  RLC-SAP: AM
  Logical channel: SCCH
  Direction: UE to UE
```

RRCReconfigurationSidelink message

-- ASN1START
-- TAG-RRCRECONFIGURATIONSIDELINK-START

| | |
|---|---|
| RRCReconfigurationSidelink ::= | SEQUENCE { |
| rrc-TransactionIdentifier-r16 | RRC-TransactionIdentifier-r16, |
| criticalExtensions | CHOICE { |
| rrcReconfigurationSidelink-r16 | RRCReconfigurationSidelink-IEs-r16 |
| criticalExtensionsFuture | SEQUENCE { } |

}
}

| RRCReconfigurationSidelink-IEs-r16 ::= | SEQUENCE { | |
|---|---|---|
| slrb-ConfigToAddModList-r16 | SEQUENCE (SIZE (1..maxNrofSLRB-r16)) OF SLRB-Config-r16 | OPTIONAL, |
| slrb-ConfigToReleaseList-r16 | SEQUENCE (SIZE (1..maxNrofSLRB-r16)) OF SLRB- [symbol] -ConfigIndex-r16 | OPTIONAL, |
| sl-MeasConfig-r16 | SL-MeasConfig-r16 | OPTIONAL, |
| sl- [symbol] - [symbol] -Config-r16 | SL- [symbol] - [symbol] -Config-r16 | OPTIONAL, |
| lateNonCriticalExtension | OCTET STRING | OPTIONAL, |
| nonCriticalExtension | SEQUENCE { } | OPTIONAL |

} [symbol]
indicates data missing or illegible when filed

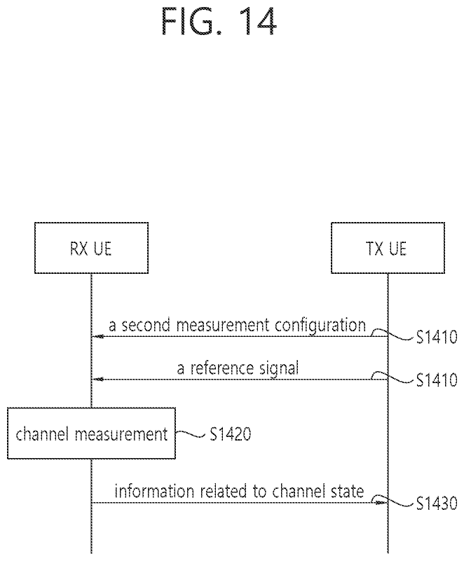

FIG. 14 shows a procedure for a transmitting UE to receive information related to a channel state, measured based on a second measurement configuration, according to an embodiment of the present disclosure. The embodiment of FIG. 14 may be combined with various embodiments of the present disclosure. Referring to FIG. 14, in step S1410, a transmitting UE (TX UE) may transmit a second measurement configuration and an RS to a receiving UE (RX UE). For example, the second measurement configuration may be generated by the transmitting UE. For example, the procedure disclosed in FIG. 14 may be a procedure performed by a UE operating in mode 2. In step S1420, the receiving UE may perform channel measurement related to the transmitting UE and the receiving UE based on the received RS and the second measurement configuration. In step S1430, the receiving UE may transmit information related to a channel state to the transmitting UE as a result of the performed channel measurement. The information related to the channel state may include CSI.

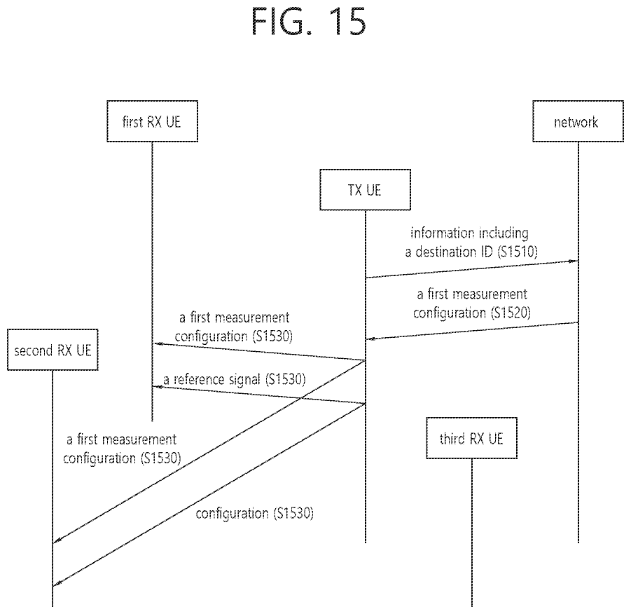

FIG. 15 shows a procedure for a transmitting UE to receive information related to a channel state from one or more receiving UEs according to an embodiment of the present disclosure. The embodiment of FIG. 15 may be combined with various embodiments of the present disclosure.

Referring to FIG. 15, a transmitting UE (TX UE) may perform sidelink communication with one or more receiving UEs (RX UE). In step S1510, the transmitting UE may transmit information including a destination ID related to the receiving UE to a base station or a network. For example, the transmitted destination ID may be a destination ID related to a part of the receiving UE performing sidelink communication with the transmitting UE. That is, for example, the transmitting UE performing sidelink communication with the first receiving UE to the third receiving UE may determine that channel measurement is necessary for the first receiving UE and the second receiving UE. And, the transmitting UE may transmit information including a destination ID related to the first receiving UE and the second receiving UE to the base station or the network. In step S1520, the base station or the network may transmit, to the transmitting UE, a first measurement configuration and a destination index for each of the receiving UEs related to the destination ID, based on the received destination ID. For example, the destination ID may correspond to each receiving UE. The destination index may correspond to a destination ID. That is, the destination index may indicate a receiving UE corresponding to a destination ID related to the destination index. In step S1530, the transmitting UE may transmit the first measurement configuration and an RS to each receiving UE that should receive the first measurement configuration based on the destination index. For example, if the transmitting UE determines that channel measurement is necessary for the first receiving UE and the second receiving UE, the transmitting UE may transmit the first measurement configuration to the first receiving UE and the second receiving UE. And, the transmitting UE may transmit the RS to the first receiving UE and the second receiving UE.

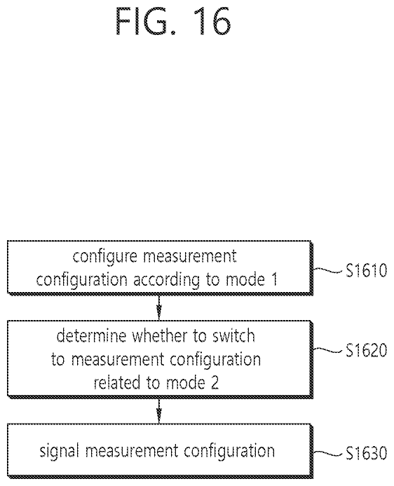

FIG. 16 shows a procedure in which a UE performs signaling of a measurement configuration according to an embodiment of the present disclosure. The embodiment of FIG. 16 may be combined with various embodiments of the present disclosure.

FIG. 16 is a flowchart showing an operation of a UE related to the above-described embodiments of the present disclosure. For example, the UE may include at least one of vulnerable road users (VRU), V2X and/or RSU. Specifically, the UE can receive a configuration of mode 1 for transmitting an SL signal through a resource allocated from a base station and a configuration of mode 2 for directly selecting a resource for transmitting the SL signal from a resource pool at the same time. In step S1610, when configuring the measurement configuration for measuring an SL channel, since resources and signaling configured by mode 1 have higher reliability than resources and signaling configured by mode 2, the UE may configure the measurement configuration according to the mode 1 to a measurement configuration for measuring the SL channel in preference to the measurement configuration according to the mode 2. For example, the measurement configuration according to mode 1 may be a measurement configuration configured by the base station. For example, the measurement configuration by mode 2 may be a measurement configuration directly configured by the UE. Next, in step S1620, the UE may determine whether to switch the measurement configuration according to the mode 1 to the measurement configuration according to the mode 2 based on a packet attribute of the SL signal. Specifically, when a round trip delay for resource allocation according to mode 1 exceeds a pre-configured threshold based on the packet attribute, the UE mat switch the measurement configuration configured by mode 1 to the measurement configuration according to mode 2. Meanwhile, after switching to the measurement configuration by mode 2, when the round trip delay for resource allocation according to mode 1 becomes a value less than or equal to a pre-configured threshold based on the packet attribute, the UE may switch back to the measurement configuration according to mode 1. Next, in step S1630, the UE may signal the configuration information for the measurement configuration to another UE. In this case, the UE may report and receive measurement information of the SL channel measured based on the measurement configuration according to the mode 2.

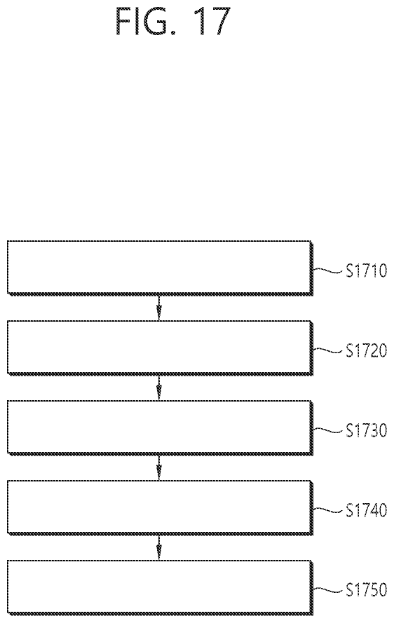

FIG. 17 shows a procedure in which a first apparatus receives information related to a channel state from a second apparatus, according to an embodiment of the present disclosure. The embodiment of FIG. 17 may be combined with various embodiments of the present disclosure.

Referring to FIG. 17, in step S1710, a first apparatus may transmit information including a destination identifier (ID) related to a second apparatus to a base station. In step S1720, the first apparatus may receive a first measurement configuration related to the destination ID from the base station, based on the destination ID. In step S1730, the first apparatus may transmit the first measurement configuration to the second apparatus, based on the destination ID. In step S1740, the first apparatus may transmit a reference signal to the second apparatus. In step S1750, the first apparatus may receive information related to a channel state from the second apparatus. For example, the channel state may be measured based on the reference signal and the first measurement configuration.

For example, the first measurement configuration may be received from the base station based on an index value related to the destination ID.

For example, the first measurement configuration may be configured to the second apparatus per destination ID.

For example, the first measurement configuration may be transmitted to the second apparatus based on the index value related to the destination ID.

For example, the information may include a destination ID related to one or more third apparatuses performing SL communication with the first apparatus.

For example, additionally, the first apparatus may determine a third apparatus which requires channel measurement among the one or more third apparatuses.

For example, the information may include a destination ID related to the third apparatus which requires the channel measurement.

For example, additionally, the first apparatus may transmit a second measurement configuration generated by the first apparatus to the second apparatus. For example, the channel state may be measured based on the reference signal and the second measurement configuration.

For example, the second measurement configuration may be transmitted to the second apparatus based on a round trip delay related to the base station, which is greater than a threshold, or which is greater than a latency budget of a packet to be transmitted.

For example, the second measurement configuration may be transmitted to the second apparatus based on reliability of a packet to be transmitted, which is lower than a threshold.

For example, additionally, the first apparatus may receive semi persistent scheduling (SPS) resources from the base station. For example, the second measurement configuration may be transmitted to the second apparatus based on a time difference between the SPS resources which is greater than a threshold.

For example, additionally, the first apparatus may transmit information related to the second measurement configuration to the base station.

For example, additionally, the first apparatus may transmit information related to SL communication to the base station. For example, the information related to the SL communication may include at least of sensing information related to a shared resource pool, preference related to a resource allocation mode of the first apparatus, usage ratio according to a resource allocation mode among resources allocated to the first apparatus, information related to a channel state between the first apparatus and the second apparatus, and/or information related to a physical layer of the first apparatus.

The above-described embodiment may be applied to various devices to be described below. For example, a processor 102 of a first apparatus 100 may control a transceiver 106 to transmit information including a destination identifier (ID) related to a second apparatus 200 to a base station 300. And, the processor 102 of the first apparatus 100 may control the transceiver 106 to receive a first measurement configuration related to the destination ID from the base station 300, based on the destination ID. And, the processor 102 of the first apparatus 100 may control the transceiver 106 to transmit the first measurement configuration to the second apparatus 200, based on the destination ID. And, the processor 102 of the first apparatus 100 may control the transceiver 106 to transmit a reference signal to the second apparatus 200. And, the processor 102 of the first apparatus 100 may control the transceiver 106 to receive information related to a channel state from the second apparatus 200. For example, the channel state may be measured based on the reference signal and the first measurement configuration.

According to an embodiment of the present disclosure, a first apparatus for performing wireless communication may be proposed. For example, the first apparatus may comprise: one or more memories storing instructions; one or more transceivers; and one or more processors connected to the one or more memories and the one or more transceivers. For example, the one or more processors may execute the instructions to: transmit information including a destination identifier (ID) related to a second apparatus to a base station; receive a first measurement configuration related to the destination ID from the base station, based on the destination ID; transmit the first measurement configuration to the second apparatus, based on the destination ID; transmit a reference signal to the second apparatus; and receive information related to a channel state from the second apparatus, wherein the channel state is measured based on the reference signal and the first measurement configuration.

According to an embodiment of the present disclosure, an apparatus configured to control a first user equipment (UE) may be proposed. For example, the apparatus may comprise: one or more processors; and one or more memories operably connectable to the one or more processors and storing instructions. For example, the one or more processors may execute the instructions to: transmit information including a destination identifier (ID) related to a second UE to a base station; receive a first measurement configuration related to the destination ID from the base station, based on the destination ID; transmit the first measurement configuration to the second UE, based on the destination ID; transmit a reference signal to the second UE; and receive information related to a channel state from the second UE, wherein the channel state is measured based on the reference signal and the first measurement configuration.

According to an embodiment of the present disclosure, a non-transitory computer-readable storage medium storing instructions may be proposed. For example, when executed, the instructions may cause a first apparatus to: transmit information including a destination identifier (ID) related to a second apparatus to a base station; receive a first measurement configuration related to the destination ID from the base station, based on the destination ID; transmit the first measurement configuration to the second apparatus, based on the destination ID; transmit a reference signal to the second apparatus; and receive information related to a channel state from the second apparatus, wherein the channel state is measured based on the reference signal and the first measurement configuration.

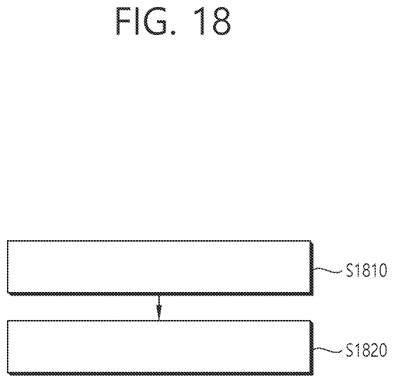

FIG. 18 shows a procedure in which a base station transmits a first measurement configuration to a first apparatus, according to an embodiment of the present disclosure. The embodiment of FIG. 18 may be combined with various embodiments of the present disclosure.

Referring to FIG. 18, in step S1810, a base station may receive information including a destination identifier (ID) related to a second apparatus from a first apparatus. In step S1820, the base station may transmit first measurement configuration related to the destination ID to the first apparatus, based on the destination ID. For example, the first measurement configuration may be transmitted to the second apparatus from the first apparatus, based on the destination ID.

For example, the first measurement configuration may be transmitted to the first apparatus and the second apparatus, based on an index value related to the destination ID.

The above-described embodiment may be applied to various devices to be described below. For example, a processor 302 of a base station 300 may control a transceiver 306 to receive information including a destination identifier (ID) related to a second apparatus 200 from a first apparatus 100. And the processor 302 of the bas station 300 may control the transceiver 306 to transmit a first measurement configuration related to the destination ID to the first apparatus 100, based on the destination ID. For example, the first measurement configuration may be transmitted to the second apparatus 200 from the first apparatus 100, based on the destination ID.

According to an embodiment of the present disclosure, a base station for performing wireless communication may be proposed. For example, the base station may comprise: one or more memories storing instructions; one or more transceivers; and one or more processors connected to the one or more memories and the one or more transceivers. For example, the one or more processors may execute the instructions to: receive information including a destination identifier (ID) related to a second apparatus from a first apparatus; and transmit a first measurement configuration related to the destination ID to the first apparatus, based on the destination ID, wherein the first measurement configuration is transmitted to the second apparatus from the first apparatus, based on the destination ID.

For example, the first measurement configuration may be transmitted to the first apparatus and the second apparatus, based on an index value related to the destination ID.

Meanwhile, in the prior art NR-Uu, if a UL transmission fails when a UE transmits an uplink packet to a base station, the base station provides a retransmission UL grant without explicit HARQ feedback, and the UE performs retransmission using the received retransmission UL grant. For example, the base station may include an eNB. However, in sidelink (SL) communication of NR-V2X, a UE may not transmit data to the base station, and a transmitting UE and a receiving UE also may not report HARQ ACK/NACK feedback to a base station. Therefore, since the base station has no information on transmission of the V2X UE, the base station may have difficulty in allocating an appropriate transmission resource to the V2X UE. In addition, in NR V2X, the resource allocation mode may operate simultaneously in a shared pool or a separate pool, in which case a switching operation between modes may be required.

Accordingly, the present disclosure proposes operations and conditions for a V2X UE operating in mode 1 to switch to mode 2 for allocation of retransmission resources, or on the other way, that a UE operating in mode 2 may use a resource allocated to mode 1 for retransmission under a specific condition to overcome these problems. In addition, a method for mode switching is also proposed. For example, in the mode 1, a base station allocates a transmission resource to a UE, and the UE may perform transmission using a grant allocated by the base station. For example, in the mode 2, the UE may perform resource allocation by itself

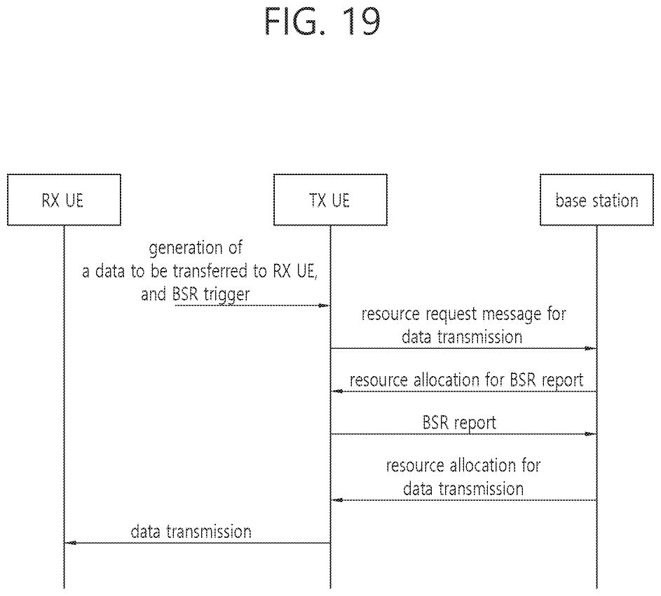

FIG. 19 shows a procedure in which a transmitting UE performs data transmission according to an embodiment of the present disclosure. The embodiment of FIG. 19 may be combined with various embodiments of the present disclosure.

Referring to FIG. 19, in a transmitting UE (TX UE), data to be transmitted to a receiving UE (RX UE) may be generated, and a trigger of the BSR may occur. In addition, the transmitting UE may transmit a resource request message for transmitting the data to a base station. And, the base station may allocate a resource for the BSR report to the transmitting UE. And, the transmitting UE may transmit a BSR report to the base station. Then, the base station may allocate the resource for the data transmission to the transmitting UE, and the transmitting UE may perform data transmission to the receiving UE based on the resource for the data transmission.

According to an embodiment of the present disclosure, method 1 may be provided. Method 1 proposes that a transmitting UE operating in mode 1 may receive resource allocation for initial TX, perform initial transmission with the corresponding resource, and if the transmitting UE receives a failure message (NACK) for initial transmission from a receiving UE, it can unconditionally select a retransmission resource through the operation of mode 2 as a default operation. For the initial transmission, the UE may be allocated a resource for the initial transmission through the process shown in FIG. 19. As for the resource allocation method of the NR SL, a gNB supports a dynamic resource allocation method and a configured grant type 1 resource allocation method. For example, the gNB may perform resource allocation by one of the two methods.

For example, after a transmitting UE receives a resource for the initial transmission from a base station, data transmission may be exchanged between the transmitting UE and the receiving UE. Here, when the transmitting UE receives a failure message (NACK) for initial transmission from the receiving UE, the transmitting UE may have to allocate a retransmission resource. In this case, the transmitting UE may allocate retransmission resources by itself through the resource pool of mode 2 pre-configured. Alternatively, for example, the transmitting UE may allocate retransmission resources by itself through a resource pool coexisting with mode 1. Therefore, through this operation, the base station may be configured to allocate only the initial transmission resource to the transmitting UE. Through this method, the transmitting UE does not need to request resource allocation in order to receive retransmission allocation from the base station, accordingly, delay related to the resource allocation request can be reduced, so that faster retransmission can be performed. As a result, even if a HARQ process between the transmitting UE and the receiving UE is considered, the delay budget of the provided service may be satisfied.

According to an embodiment of the present disclosure, method 2 may be provided. Method 2, like method 1, proposes a method of using a resource allocated from mode 1 for initial transmission, but using mode 2 when a specific triggering condition is satisfied. This method may be interpreted as that an operation of a UE may be limited so that retransmission or initial transmission is performed through a resource allocated to mode 1 if possible. That is, a UE is configured to preferentially use a resource allocated from a base station through the mode 1 operation, and when the following condition is satisfied, the UE may switch to the mode 2 operation and perform resource selection. Here, For example, the time point when a UE performs a switching operation in mode 2 may be initial transmission time, time to select retransmission resources after initial transmission in mode 1, or time to select subsequent retransmission resources. For example, since the method in which a base station allocates resources to a UE may be more reliable than the method in which the UE selects resources by itself, a UE may preferentially use the mode 1 resource according to the above-described method, or the UE may use the mode 2 resource only when a specific condition is satisfied.

First, for example, there may be a triggering condition in terms of reliability of a transmitted packet. For example, if there is a QoS metric mapped per packet or per flow, when a reliability parameter is lower than a specific threshold, a UE may switch to mode 2. For example, in the case of LTE, the QoS metric may include ProSe Per Packet Reliability (PPPR). Here, it may mean that a packet or service having a reliability parameter smaller than a specific threshold corresponds to a packet or service having low reliability. Accordingly, if a packet or service having a small reliability QoS parameter is configured as a packet or service having a high reliability, a case in which the reliability parameter is greater than a specific threshold may be a switching triggering condition of mode 2.

For example, there may be a triggering condition from a latency budget point of view. For example, when dynamic scheduling is performed, a process for requesting a retransmission resource may be required. For example, the process for requesting the retransmission resource may consists of transmitting, by the UE, an SR to a base station; receiving, by the UE, a grant for BSR from the base station; transmitting, by the UE, a BSR to the base station; receiving, by the UE, a grant for data transmission from the base station. For example, when the delay caused by the scheduling round trip delay exceeds the delay budget to be supported by the V2X service, the UE may switch to mode 2 and perform resource selection. For example, when a packet's delay budget deadline is t_d, a UE may attempt to switch to mode 2 when N+M>t_d. Here, N may be a scheduling delay from a base station generated by mode 1 operation, and M may be a processing delay generated when data transmission is performed using an allocated resource.

According to an embodiment of the present disclosure, in NR V2X, a minimum communication range is configured as a new QoS parameter, and this parameter can determine whether or not to transmit HARQ feedback of V2X PC5 communication. In other words, only a UE existing within the minimum communication range mapped to the service that a transmitting UE will transmit is the subject of interest in the HARQ process, and the transmitting UE may receive only HARQ feedback transmitted from UEs existing within the minimum communication range. However, the HARQ feedback transmitted outside the minimum communication range may still be received from the viewpoint of the transmitting UE. For example, when the transmitting UE receives the HARQ feedback transmitted outside the minimum communication range, it may be because a distance calculation error or a UE transmitting the HARQ feedback considers the minimum communication range related to another transmitting UE. For example, when the UE receives the HARQ feedback transmitted outside the minimum communication range, the HARQ feedback may be considered to be related to a relatively less important packet. Therefore, if the geographic distance or radio distance between the transmitting UE and the receiving UE is tracked, or if the transmitting UE is able to know the geographic distance or the radio distance, retransmission resources for HARQ feedback from UEs outside the minimum communication range may be selected through mode 2 operation. Alternatively, for example, resource occupation for initial transmission with a UE outside the minimum communication range may be performed in mode 2. In this case, the transmitting UE may not use the resource allocated in mode 1 in advance for transmission. And, the transmitting UE may use the resource allocated in the mode 1 in advance for the next initial transmission.

According to an embodiment of the present disclosure, when the data rate of a packet to be transmitted by a UE is less than a specific threshold, the UE may be configured to perform mode 2 operation. For example, the operation of selecting a resource in mode 2 has lower resource reliability than receiving resource allocation through mode 1, if a UE selects resources in mode 2, it may be disadvantageous for the UE to occupy more resources. For example, low resource reliability may mean a high interference level. Accordingly, the UE may operate in mode 2 when the data rate is small, and select mode 1 operation in the case of packets having a relatively large data rate.

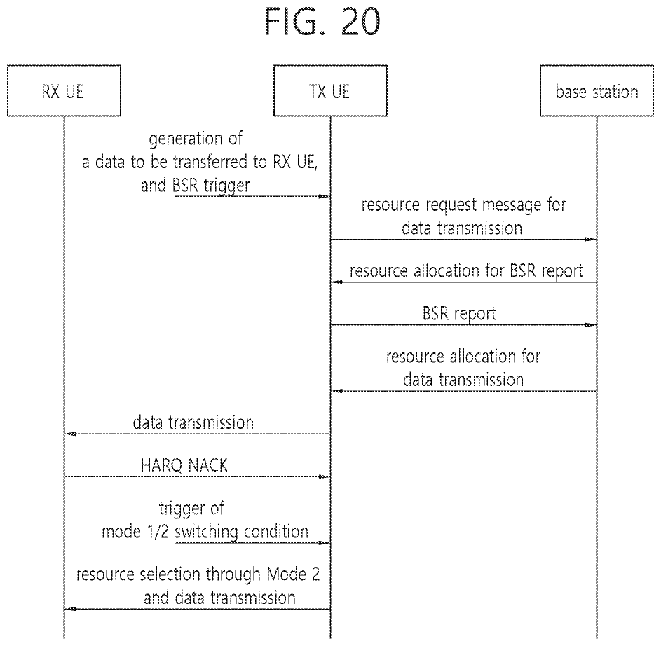

FIG. 20 shows a procedure in which a transmitting UE performs data transmission based on resource selection through mode 2 according to an embodiment of the present disclosure. The embodiment of FIG. 20 may be combined with various embodiments of the present disclosure.

Referring to FIG. 20, a data to be transmitted from a transmitting UE (TX UE) to a receiving UE (RX UE) may be generated, and a BSR trigger may occur. In addition, the transmitting UE may transmit a resource request message for transmitting the data to a base station. And, the base station may allocate a resource for the BSR report to the transmitting UE. And, the transmitting UE may transmit a BSR report to the base station. Then, the base station may allocate the resource for the data transmission to the transmitting UE, and the transmitting UE may perform data transmission to the receiving UE based on the resource for the data transmission. Here, the receiving UE may transmit a HARQ NACK related to the data to the transmitting UE. And, the transmitting UE may perform a mode 1/mode 2 switching operation based on the above-described triggering condition. And, the transmitting UE may perform resource selection and data transmission based on the operation of mode 2.

For example, as mentioned above, when a UE allocated an initial transmission resource in mode 1 allocates a retransmission resource, the above triggering condition may be used for the UE to perform switching between mode 1/mode 2, or may be a condition for which mode the UE selects in initial transmission. For example, FIG. 20 shows an operation when a switching condition is satisfied through method 2 and switching is triggered.

According to an embodiment of the present disclosure, when a UE operating in a specific mode performs mode switching based on the above condition, the UE may fall back to the original operating mode again. For example, when a UE operating in mode 1 switches to mode 2, and a packet to be newly transmitted is delay insensitive, the UE may fall back to mode 1 again and receive resource allocation from a base station. For example, a case in which the packet is insensitive to delay may include a case in which a delay budget of a new service becomes larger than a scheduling delay of mode 1 again. In addition, for example, when the metric corresponding to the above condition as well as the delay budget satisfies the opposite condition, a UE that has switched can fall back to the original mode again. In addition, for example, if the mode 2 resource pool is configured independently, when the congestion level of a mode 2 resource pool is higher than a specific threshold, a UE that has switched to mode 2 may fall back to mode 1 again. These operations may be performed when it is expected that many other UEs are trying to occupy resources in the vicinity for the UE to perform resource scheduling in mode 2. That is, the UE may perform communication based on resource allocation of a base station.

According to an embodiment of the present disclosure, method 3 is provided. For example, as method 3, there may be a mode switching operation performed for allocating an initial or retransmission resource according to a base station coverage. In LTE V2X, if a UE is in an RRC connection state within the base station coverage, resources are allocated from the base station, and in other cases (including out-of-coverage), the UE may perform resource selection by using a pre-configured resource pool by itself. Here, for example, the case when the UE is not in the RRC connection state within the coverage of the base station may include an out-of-coverage situation. For example, in NR V2X, mode selection can be performed similarly to LTE. However, in order for a base station to perform all resource allocation management, in the case of a UE within coverage, it may be configured such that the base station performs all allocation of initial/retransmission resources. On the other hand, in the case of out of coverage, a UE may perform resource selection in mode 2 by mode switching. That is, through the above method, mode 1 may be selected for a UE within coverage, and mode 2 may be selected for a UE outside of coverage.

According to an embodiment of the present disclosure, method 4 is provided. For example, method 4 proposes that a UE may receive resource allocation by operating in mode 1 for initial transmission scheduling, and that retransmission resources may be scheduled from a neighboring scheduling UE (S-UE). Here, for example, the scheduling UE may be a specific UE designated by a platooning leader or a group leader or a base station. The scheduling UE may forward a resource grant received from a base station to a peripheral scheduled UE or perform scheduling. For example, the above operation may be required when a UE transmits a packet for a delay sensitive service. For example, when a UE receives NACK feedback after initial transmission with resources allocated from mode 1, and the scheduling delay for the UE to receive retransmission resources allocated from a base station is excessively large, the UE may receive help from a neighboring scheduling UE. For example, a UE in which the simultaneous operation mode is configured in NR V2X may have a higher priority to the operation performed in mode 1, then the UE may perform initial transmission (or retransmission) resource allocation in mode 2 operation through a grant received from a neighboring scheduling UE while operating in mode 1. For example, specifically, a scenario in which a retransmission resource is allocated may be as follows. First, if a transmitting UE is allocated a resource through mode 1 operation for initial transmission, performs data transmission to a receiving UE using the resource, receives a HARQ NACK feedback from the receiving UE, or if the delay for allocating the retransmission resource to the base station is excessively large, the transmitting UE may perform retransmission through a mode 2 grant previously configured from a neighboring scheduling UE. For example, the case in which the delay for allocating the retransmission resource to the base station is excessively large may include a case in which the delay is larger than the delay budget. For example, if a transmitting UE does not have a previously configured grant, it may request allocation of a retransmission resource after an association with a neighboring scheduling UE.

According to an embodiment of the present disclosure, method 5 is provided. For example, method 5 proposes a method of giving priority to mode 1 if it is not a big problem overall even if simultaneous mode operation is configured for a UE. Basically, as mentioned above, the reliability of the resource allocated in the mode 1 is higher among the reliability of the resources allocated in the operation of mode 1/mode 2. In addition, there may be no good reason not to use resources allocated by a base station within the coverage of the base station from the standpoint of a UE. However, for example, in order to support V2X services in which safety-related services are the main services, it may be necessary to achieve data reception success within a specific delay budget. Therefore, in this proposal, a UE supporting the mode 1 operation performs initial transmission/retransmission through resources allocated from a base station as much as possible. Here, for example, when a UE attempts SR/BSR to receive retransmission resource allocation, an error occurs in the Uu interface and it becomes difficult for the UE to receive the grant within the delay budget, the UE may operate in mode 2. For example, such an operation may mean limiting the operation of the UE to use the resource when there is a resource allocated to mode 1 if possible.

According to an embodiment of the present disclosure, method 6 is provided. For example, in method 6, if a UE configured to operate in the simultaneous mode occupies a resource in mode 2, but later, if another resource is configured by a base station to the UE through mode 1, the UE may be configured to use first the resource scheduled in mode 1. For example, the resource occupied in mode 2 may be a resource occupied in advance. For example, if this method is substituted for the problem of allocation of retransmission resources, a UE that allocates and reserves a first resource in the mode 2 operation may perform initial transmission/retransmission through a second resource when the second resource is configured from the mode 1 later. Also, for example, this operation may simply be an operation for mode selection of a UE. That is, when a UE performing initial transmission/retransmission in mode 2 receives a resource allocation grant from a base station, the UE may hold the resource reserved for mode 2 and perform transmission using the resource allocated from the base station first. For example, a resource reserved for mode 2 may be released while performing an operation according to mode 1, or the UE may reserve the resource reserved for the mode 2 as it is and use the resource reserved for the mode 2 after the scheduling according to the mode 1 is finished.

For example, in the method proposed above, a UE may be configured to report specific information to a base station according to mode switching. For example, if a UE operating in mode 1 performs mode switching to mode 2, the UE may report an indication for mode switching. Through this indication information for mode switching, the base station may recognize that the UE has switched to mode 2 operation and stop mode 1 resource allocation. In addition, for example, a UE may report usage ratio of the mode 2 resource after switching to mode 2. Through this information, the base station can determine whether to schedule mode 1 to the corresponding UE. In addition, for example, if a UE uses a resource pool shared by mode 1/mode 2, when the UE reports the mode 2 resource ratio and resource selection information to a base station, a base station may attempt mode 1 scheduling so that the UE avoids the corresponding resource. In addition, for example, a UE may report a specific parameter to a base station, and the base station may determine whether the UE is to switch mode 1/mode 2. For example, the parameter may include: resource sensing information of the shared resource pool, mode 1/mode 2 preference of a UE, whether a UE is internally switched, and/or use ratio of mode 1/mode 2 resources among the mode 1/mode 2 allocated resources, etc. That is, a base station may explicitly signal a mode switching indication to a UE based on the parameter reported by the UE, or may implicitly inform the UE by allocating an independent resource pool for the mode to the UE.

Therefore, according to the above, in the present disclosure, when data transmission between UEs in NR SL V2X, or when data transmission fails, disclosed is a method for enabling data transmission between UEs by rapidly and reliably allocating transmission resources by a UE and improving reliability of data transmission through this.

For example, although the present disclosure was written as a main target for the case where the time point for the written mode switching is the time point of occupying the retransmission resource, it is proposed that the time point for the mode switching may be the time point at which the initial resource is occupied. That is, a scenario for mode switching when allocating retransmission resources after initial resource allocation is described below, but retransmission resource allocation may be another initial resource allocation process.

In the present disclosure, when Uu beam management is supported in NR SL, a method for solving a problem that may occur when a Uu beam failure occurs from a mode switching point of view is proposed.

According to an embodiment of the present disclosure, if a Uu beam failure occurs in a mode 1 UE performing an SL operation, the easiest method is that the UE may perform resource transmission through a pre-configured resource pool. For example, the pre-configured resource pool may include an exceptional resource pool. In addition, for example, if the UE receives a pre-configured grant resource, the UE can perform transmission to the corresponding resource to prevent communication delay. In addition, from the viewpoint of the delay budget, when a UE receives the configured grant resource rather than the dynamic scheduling in the scheduling of mode 1, the UE may switch to 2 and perform resource selection. For example, even if a base station allocates a grant resource configured to a UE based on the UE assistance information received from the UE in advance, if the delay budget of the data to be transmitted by the UE is smaller than a resource period of a pre-configured, configured resource, the UE may perform resource selection by switching to mode 2. For example, if Uu beam management is supported in NR SL, if Uu beam failure occurs, in order to solve the problem that a UE does not receive an appropriate resource allocation from a base station, such a situation may be a scenario for preventing communication delay due to Uu beam failure from occurring by allowing the UE to use which resource among the pre-configured mode 1 resource and mode 2 resource. For example, the pre-configured mode 1 resource may include a configured grant resource. For example, the mode 2 resource may include a normal resource pool. That is, if the characteristics of data traffic to be transmitted by a UE correspond to the configured grant resource, and do not cause problems related to the packet delay budget or the physical layer, the UE may use the configured grant resource as it is. Conversely, however, when a grant resource configured as described above is not appropriate, the UE may select a mode 2 resource to prevent communication delay. For example, the data traffic may include a packet period or a packet size. In addition, for example, if more priority is given to mode 1 resources, a UE may perform resource transmission using the normal resource pool of mode 2 after using all of the pre-configured mode 1 resources.

Meanwhile, in NR V2X, mode 1 and mode 2 were configured as resource allocation modes. Here, mode 1 is a mode in which a base station performs resource allocation scheduling of a UE and grants a resource grant to the UE, and mode 2 is a mode in which a UE performs resource selection independently without involvement of a base station.

In this resource allocation mode, mode 1 and mode 2 may be simultaneously configured in a resource pool configured for one UE as follows. For example, even if a UE has received a mode 1 grant from a base station, the UE may receive a mode 2 resource pool configured from the base station or in advance. Alternatively, for example, and vice versa. For example, the grant of the mode 1 may include a grant based on a dynamic scheduling request or a configured grant. According to the description below, a UE can receive configurations related to mode 1 and mode 2 at the same time, and it is an issue whether a base station can configure this in what form or under what conditions the UE performs mode switching.

Table 11 below shows that mode 1 and mode 2 can be simultaneously configured in the resource allocation mode of a UE.

TABLE 11
1. Support for simultaneous configuration of Mode 1 and Mode 2 for a UE
1.1) Transmitter UE operation in this configuration is to be discussed
after the design of mode 1 only and mode 2 only.
1.2) Receiver UE can receive the transmissions without knowing the
resource allocation mode used by the transmitter UE.
2. Reference : [3GPP RP-190766]

In the present disclosure, conditions and scenarios are proposed when the simultaneous mode is configured to a UE, the UE, which was performing SL communication through a grant of mode 1, can occupy and transmit resources through a resource pool of mode 2 configured at the same time.

According to an embodiment of the present disclosure, when the mode 1 grant received by a UE from a base station does not accommodate all of the PDUs to be transmitted by the UE, the UE may switch to mode 2. For example, a UE may receive a grant configured for SL transmission from a base station in the format of type 1 or type 2 without L1 signaling through RRC signaling. In this case, the base station may configure the resource period, time/frequency resource allocation (in case of type 1), the number of repetitions, and other L1 parameters (in case of type 1). In this case, the UE may have to perform data transmission with a size of a resource determined by the base station. Here, if the UE wants to perform a service that requires a high data rate, there may be a problem in that the UE cannot transmit all of the PDUs to be transmitted through the configured grant resource. In this case, in the prior art, the UE performs a process for receiving the reconfigured mode 1 grant. On the other hand, according to an embodiment of the present disclosure, a UE in which the simultaneous mode configuration is configured may switch to mode 2 and perform occupation of a resource capable of accommodating all of the transmission PDUs. For example, in the above example, even if the UE cannot accommodate all of the PDUs to be transmitted by the UE, not only the configured grant resources, but also the dynamic grant received from the eNB through SR/BSR in advance, the UE may occupy a resource by switching to mode 2 without performing SR/BSR for receiving resource reconfiguration in mode 1.

According to an embodiment of the present disclosure, a UE may switch to mode 2 without using a resource related to mode 1 allocated to the UE based on the sidelink channel condition. A UE is allocated a resource related to mode 1 based on a resource scheduling request related information from a base station. Here, for example, the resource scheduling request related information may include SR/BSR, SL UE information (sidelinkUEinformation), and/or UE assistance information. At this time, in a base station scheduling of mode 1 according to the prior art, the base station performed resource scheduling in consideration of the size, period, and destination ID of data to be transmitted by a UE without considering the situation related to the inter-sidelink link. However, according to a base station scheduling of mode 1 according to the prior art, even if a UE satisfies the coding rate as much as the resources allocated by the base station and transmits due to the poor channel environment between the sidelinks, the receiving end may not show proper reception performance. For example, the situation related to the inter-sidelink link may include channel quality, interference environment, and the like.

In NR SL, the exchange of channel conditions between sidelinks is supported. Here, for example, the exchange for the channel condition may be made through CSI reporting. Accordingly, a transmitting UE may measure the channel condition from a receiving UE performing SL communication, or receive information about the channel condition measured by the receiving UE. For example, the channel condition measured by the receiving UE may include a channel quality indicator (CQI), a rank indication (RI), and the like. If, for example, the channel environment reported by a transmitting UE from a receiving UE is worse than a certain degree, the transmitting UE configured to the simultaneous mode may increase the coding rate by switching to mode 2 and occupying more resources without using the allocated resource of mode 1. In this way, a higher reception success rate of sidelink communication performed by a UE can be satisfied.

According to an embodiment of the present disclosure, after a UE receives a mode 1 grant from a base station, when the grant is deactivation/release, the destination and bearer mapped to the corresponding grant may be switched to mode 2. For example, the mode 1 grant may include a configured grant. For example, a base station may allocate a configured grant of type 1 or type 2 of mode 1 to a UE, and may deactivate or release the configured grant through RRC or L1 signaling. For example, in a normal case, a UE may transmit information that there is no longer an interest in SL communication to a base station through SL UE information (sidelinkUEinformation), then, the base station may perform deactivation or release of the configured grant. On the other hand, a base station may perform deactivation/release of an SL grant for management of resources in the cell. For example, the management may be an operation of releasing an allocated SL-configured grant resource for urgent UL transmission. Then, UEs operating in the sidelink receive a resource deactivation/release message from the base station regardless of whether they are interested in SL transmission, in this case, the UEs may switch the destination and bearer mapped to the grant to mode 2 in order to prevent stopping of the resource in which transmission is in progress, and perform resource selection. That is, even though the UE did not report to the base station information that the UE is not interested in SL communication, when a deactivation/release message for a grant is received from the base station to the UE, the UE may switch a destination and a bearer for the corresponding grant to mode 2. For example, the information that the UE is not interested in SL communication may include SL UE information (sidelinkUEinformation).

According to an embodiment of the present disclosure, an SL UE may switch to mode 2, when the SL UE transmits an SR/BSR to a base station for SL dynamic scheduling, the SL SR/BSR cannot be transmitted to the base station due to collision with UL transmission or UL/SL prioritization. Alternatively, for example, when an SL UE transmits an SR/BSR to a base station for SL dynamic scheduling, when it fails to transmit information related to the corresponding destination or bearer for the SL communication to the base station, the SL UE may switch to mode 2.

For example, due to the collision of the L1 uplink channel for transmitting SR/BSR for SL communication and the L1 uplink channel for transmitting UL data or control information for the Uu interface, a UE may fail to transmit PUCCH for SL SR/BSR. For example, the uplink channel may include PUCCH. In this case, there may be a delay in grant scheduling from the base station, and the UE may fail to transmit the V2X service having a tight latency requirement. As such, when a collision of PUCCHs related to SL SR/BSR occurs, a UE may attempt resource occupation by switching to mode 2 in relation to transmission of a packet to be transmitted.

In addition, for example, there is an issue about which transmission has priority between UL transmission and SL transmission, so that it is transmitted first, it is called UL/SL prioritization. In UL/SL prioritization, if a UE prioritizes SL transmission according to a configured rule, there may be a delay in UL transmission for transmitting SR/BSR for SL communication. For example, when resource scheduling is not received in time due to this, or information on the corresponding destination or bearer cannot be transmitted to a base station, the UE may switch to mode 2.

Hereinafter, after a UE switches from mode 1 to mode 2, it is proposed how to process the remaining mode 1 resources.

According to an embodiment of the present disclosure, a UE switched to mode 2 may suspend the mode 1 grant, and may perform transmission by falling back to the reserved mode 1 grant for a new transmission PDU. For example, a UE suspends the mode 1 grant as it is, and when a request for a new transmission PDU occurs after completing transmission in the switched mode 2, it may fall back to mode 1 and use the reserved mode 1 grant.

According to an embodiment of the present disclosure, a UE may request a base station to release the mode 1 grant. For example, the UE may transmit a release request for the mode 1 grant or indication information for mode change to the base station through an uplink message. Thereafter, the base station may allocate a new mode 1 grant to the UE.

Hereinafter, an apparatus to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

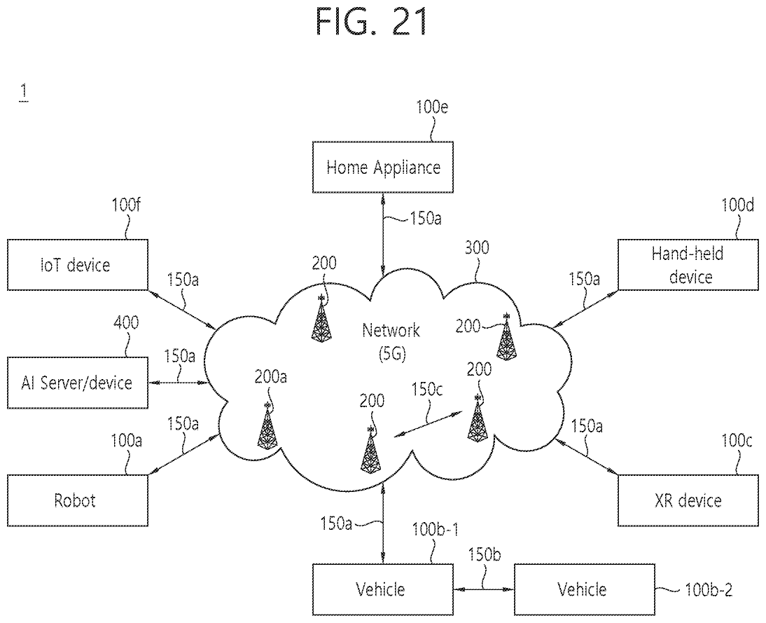

FIG. 21 shows a communication system 1, in accordance with an embodiment of the present disclosure.

Referring to FIG. 21, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

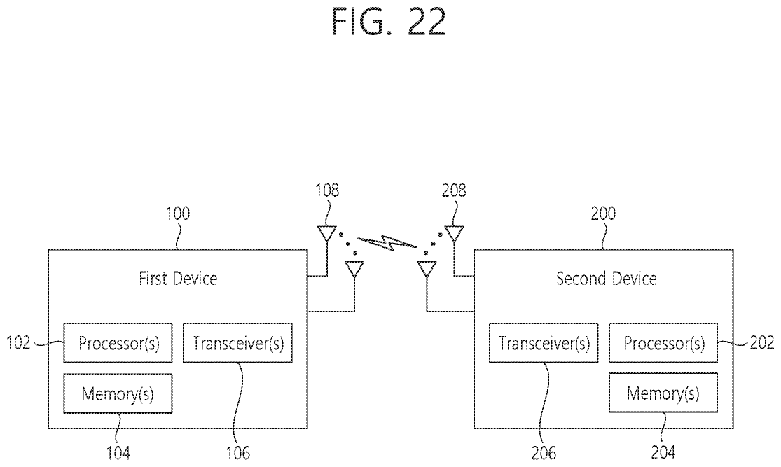

FIG. 22 shows wireless devices, in accordance with an embodiment of the present disclosure.

Referring to FIG. 22, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 21.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

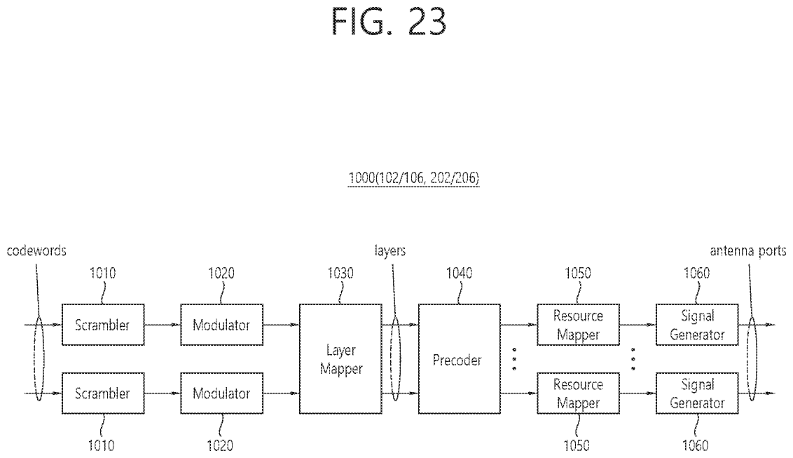

FIG. 23 shows a signal process circuit for a transmission signal, in accordance with an embodiment of the present disclosure.

Referring to FIG. 23, a signal processing circuit 1000 may include scramblers 1010, modulators 1020, a layer mapper 1030, a precoder 1040, resource mappers 1050, and signal generators 1060. An operation/function of FIG. 23 may be performed, without being limited to, the processors 102 and 202 and/or the transceivers 106 and 206 of FIG. 22. Hardware elements of FIG. 23 may be implemented by the processors 102 and 202 and/or the transceivers 106 and 206 of FIG. 22. For example, blocks 1010 to 1060 may be implemented by the processors 102 and 202 of FIG. 22. Alternatively, the blocks 1010 to 1050 may be implemented by the processors 102 and 202 of FIG. 22 and the block 1060 may be implemented by the transceivers 106 and 206 of FIG. 22.

Codewords may be converted into radio signals via the signal processing circuit 1000 of FIG. 23. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 23. For example, the wireless devices (e.g., 100 and 200 of FIG. 22) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

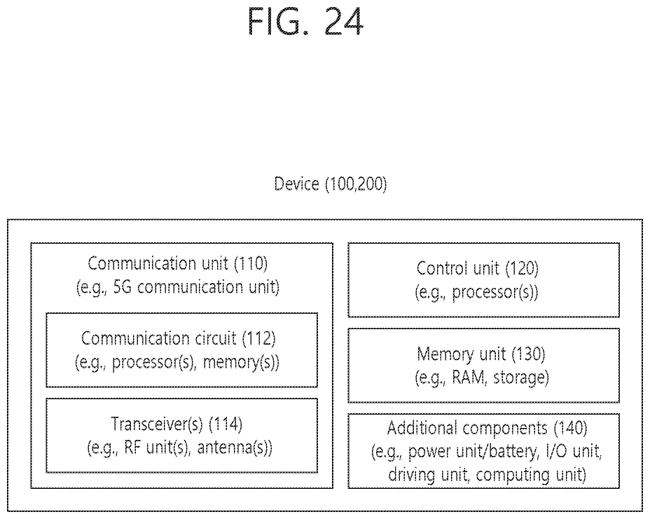

FIG. 24 shows another example of a wireless device, in accordance with an embodiment of the present disclosure. The wireless device may be implemented in various forms according to a use-case/service (refer to FIG. 21).

Referring to FIG. 24, wireless devices 100 and 200 may correspond to the wireless devices 100 and 200 of FIG. 22 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 22. For example, the transceiver(s) 114 may include the one or more transceivers 106 and 206 and/or the one or more antennas 108 and 208 of FIG. 22. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 21), the vehicles (100b-1 and 100b-2 of FIG. 21), the XR device (100c of FIG. 21), the hand-held device (100d of FIG. 21), the home appliance (100e of FIG. 21), the IoT device (100f of FIG. 21), a digital broadcast terminal, a hologram device, a public safety device, an MTC device, a medicine device, a fintech device (or a finance device), a security device, a climate/environment device, the AI server/device (400 of FIG. 21), the BSs (200 of FIG. 21), a network node, etc. The wireless device may be used in a mobile or fixed place according to a use-example/service.

In FIG. 24, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 24 will be described in detail with reference to the drawings.

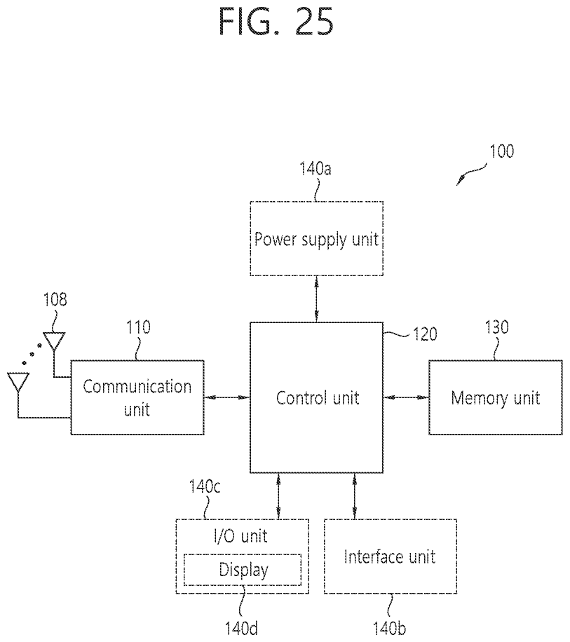

FIG. 25 shows a hand-held device, in accordance with an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 25, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 24, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

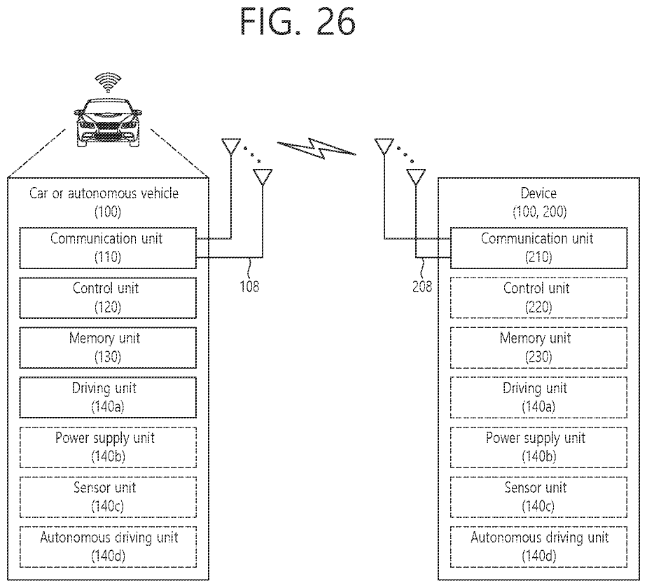

FIG. 26 shows a vehicle or an autonomous vehicle, in accordance with an embodiment of the present disclosure. The vehicle or autonomous vehicle may be implemented by a mobile robot, a car, a train, a manned/unmanned Aerial Vehicle (AV), a ship, etc.

Referring to FIG. 26, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 24, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

What is claimed is:

1. A method for performing, by a first apparatus, wireless communication, the method comprising:
transmitting information including a destination identifier (ID) related to a second apparatus to a base station;
receiving a first measurement configuration related to the destination ID from the base station, based on the destination ID;
transmitting the first measurement configuration to the second apparatus, based on the destination ID;
transmitting a reference signal to the second apparatus; and
receiving information related to a channel state from the second apparatus,
wherein the channel state is measured based on the reference signal and the first measurement configuration.

2. The method of claim 1, wherein the first measurement configuration is received from the base station based on an index value related to the destination ID.

3. The method of claim 2, wherein the first measurement configuration is configured to the second apparatus per destination ID.

4. The method of claim 2, wherein the first measurement configuration is transmitted to the second apparatus based on the index value related to the destination ID.

5. The method of claim 1, wherein the information includes a destination ID related to one or more third apparatuses performing SL communication with the first apparatus.

6. The method of claim 5, further comprising:
determining a third apparatus which requires channel measurement among the one or more third apparatuses.

7. The method of claim 6, wherein the information includes a destination ID related to the third apparatus which requires the channel measurement.

8. The method of claim 1, further comprising:
transmitting a second measurement configuration generated by the first apparatus to the second apparatus,
wherein the channel state is measured based on the reference signal and the second measurement configuration.

9. The method of claim 8, wherein the second measurement configuration is transmitted to the second apparatus based on a round trip delay related to the base station, which is greater than a threshold, or which is greater than a latency budget of a packet to be transmitted.

10. The method of claim 8, wherein the second measurement configuration is transmitted to the second apparatus based on reliability of a packet to be transmitted, which is lower than a threshold.

11. The method of claim 8, further comprising:
receiving semi persistent scheduling (SPS) resources from the base station,
wherein the second measurement configuration is transmitted to the second apparatus based on a time difference between the SPS resources which is greater than a threshold.

12. The method of claim 8, further comprising:
transmitting information related to the second measurement configuration to the base station.

13. The method of claim 1, further comprising:
transmitting information related to SL communication to the base station,
wherein the information related to the SL communication includes at least of sensing information related to a shared resource pool, preference related to a resource allocation mode of the first apparatus, usage ratio according to a resource allocation mode among resources allocated to the first apparatus, information related to a channel state between the first apparatus and the second apparatus, and/or information related to a physical layer of the first apparatus.

14. A first apparatus for performing wireless communication, the first apparatus comprising:
one or more memories storing instructions;
one or more transceivers; and
one or more processors connected to the one or more memories and the one or more transceivers, wherein the one or more processors execute the instructions to:
transmit information including a destination identifier (ID) related to a second apparatus to a base station;
receive a first measurement configuration related to the destination ID from the base station, based on the destination ID;
transmit the first measurement configuration to the second apparatus, based on the destination ID;
transmit a reference signal to the second apparatus; and
receive information related to a channel state from the second apparatus,
wherein the channel state is measured based on the reference signal and the first measurement configuration.

15. An apparatus configured to control a first user equipment (UE), the apparatus comprising:
one or more processors; and
one or more memories operably connectable to the one or more processors and storing instructions, wherein the one or more processors execute the instructions to:
transmit information including a destination identifier (ID) related to a second UE to a base station;
receive a first measurement configuration related to the destination ID from the base station, based on the destination ID;
transmit the first measurement configuration to the second UE, based on the destination ID;
transmit a reference signal to the second UE; and
receive information related to a channel state from the second UE,
wherein the channel state is measured based on the reference signal and the first measurement configuration.
